(19) United States
(12) Patent Application Publication
(10) Pub. No.: US 2007/0011996 A1
(43) Pub. Date: Jan. 18, 2007

(54) Electric vacuum cleaner

(75) Inventors: Yoshihiro Tsuchiya, Shizuoka (JP); Masatoshi Tanaka, Kanagawa (JP); Atsushi Morishita, Kanagawa (JP); You Torizawa, Kanagawa (JP); Yasushi Takai, Kanagawa (JP); Mai Matsuno, Kanagawa (JP); Ai Tanaka, Tokyo (JP); Mitsuru Watanabe, Kanagawa (JP); Akiko Tairaku, Kanagawa (JP); Ritsuo Takemoto, Kanagawa (JP); Yukio Machida, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/485,806

(22) Filed: Jul. 13, 2006

(30) Foreign Application Priority Data
Jul. 13, 2005 (JP) 2005-204009
Aug. 26, 2005 (JP) 2005-246821
Aug. 26, 2005 (JP) 2005-246818

(51) Int. Cl. B01D 46/04

(52) U.S. Cl. 55/298

(57) ABSTRACT

An electric vacuum cleaner including a main body, a filter located in a suction air trunk between an inlet to suck dust and a suction opening of an electric blower and provided in the main body to adsorb the dust, a filter dust-removal device to remove the dust attached to the filter, a dust receiving part to receive the dust removed from the filter and having an outlet through which the dust is discharged, and a dust discharge device configured to discharge the dust in the dust receiving part from the outlet, the dust discharge device having a discharge member configured to discharge dust from the outlet and to be capable of closing the outlet.

### CROSS-REFERENCE TO THE RELATED APPLICATIONS

This application is based on and claims the priority benefit of each of Japanese Patent Application No. 2006-204009, filed on Jul. 13, 2005, Japanese Patent Application No. 2005-246821, filed on Aug. 26, 2005, and Japanese Patent Application No. 2005-246818, filed on Aug. 26, 2005, the contents of which are incorporated herein by reference.

### BACKGROUND OF THE INVENTION

1. Field of the Invention

The present invention relates to an electric vacuum cleaner capable of removing dust from a filter rotatably provided in a suction air trunk formed in a main body and recovering the removed dust efficiently.

2. Description of Related Art

Conventionally known is an electric vacuum cleaner in which a dust collection container is rotatably provided in a main body (for reference, see Japanese Patent Laid-Open No. 2004-358135).

The electric vacuum cleaner includes a main body in which a dust collection chamber is formed and a dust collection container removably disposed in the dust collection chamber, an electric blower provided downstream the dust collection chamber, a pleated filter which is a secondary filter and removably attached to a back opening of the dust collection container, and dust removal means removing the dust attached to the pleated filter from the filter. Here, pleats of the pleated filter extend upwardly and downwardly.

The dust removal means is configured to have a ring disposed in a position facing the pleated filter rotatably, and a protrusion provided to abut with the pleated filter on the ring, rotate the ring when a power cord is wound about a cord reel, and move the protrusion over mountains of the pleats of the pleated filter by the rotation of the ring to give vibrations to the pleated filter, thereby the dust attached to the pleated filter is removed.

However, in such an electric vacuum cleaner, there is a problem that the dust removed from an upper portion of the pleated filter drops downwardly because the pleats extend upwardly and downwardly when the protrusion of the ring moves on the upper portion of the pleated filter, while the dust is attached to a lower portion of the pleated filter again.

### SUMMARY OF TH INVENTION

An object of the present invention is to provide an electric vacuum cleaner in which dust removed from a filter is efficiently discharged from an outlet without being attached to the filter again.

To accomplish the above-mentioned object, an electric vacuum cleaner according to one embodiment of the present invention includes a main body, a filter located in a suction air trunk between an inlet to suck dust and a suction opening of an electric blower and provided in the main body to adsorb the dust, a filter dust-removal device to remove the dust attached to the filter, a dust receiving part to receive the dust removed from the filter and having an outlet through which the dust is discharge, and a dust discharge device configured to discharge the dust in the dust receiving part from the outlet.

The dust discharge device includes a discharge member configured to move the dust contained in the dust receiving part to the outlet and a drive mechanism to drive the discharge member. The discharge member is formed to be capable of closing the outlet.

With the above-mentioned structure, the outlet is closed by the discharge member, and therefore it is prevented that the dust discharged from the outlet is sucked through the outlet and attached to the filter again.

### BRIEF DESCRIPTION OF THE DRAWINGS

FIG. 1 is a perspective view showing an outer shape of an electric vacuum cleaner according to a first embodiment of the present invention.

FIG. 2 is a longitudinal-sectional view showing a structure in a main body of the electric vacuum cleaner shown in FIG. 1.

FIG. 3 is a perspective view showing the main body in which a cover and a dust collection unit are removed.

FIG. 4 is a partial perspective view of the main body with partially sectioned.

FIG. 5 is a longitudinal-sectional view showing the main body in which the cover and the dust collection unit are removed.

FIG. 6 is a perspective view showing an outer shape of the dust collection unit.

FIG. 7 is a cross-sectional view of the dust collection unit shown in FIG. 6.

FIG. 8 is a longitudinal-sectional view of the dust collection unit shown in FIG. 6.

FIG. 9 is a perspective view showing an outer shape of a dust collection part.

FIG. 10 is an explanatory view showing a front wall portion of a containing case and a blade structure.

FIG. 11 is a perspective view showing the containing case and a dust separation part.

FIG. 12 is a perspective view showing ribs of a pleated filter.

FIG. 13 is a side view showing a pleated filter structure.

FIG. 14 is an explanatory view showing a state where the ribs of pleats of the pleated filter structure and the blade structure are stacked.

FIG. 15 is a perspective view showing the containing case and the blade structure.

FIG. 16 is an explanatory view showing a positional relationship between a dust receiving part and blades.

FIG. 17 is a block view showing a structure of a control system of the electric vacuum cleaner.

FIG. 18 is a sectional view of an electric vacuum cleaner according to a second embodiment of the present invention.

FIG. 19 is a perspective view showing an outer shape of a dust collection unit in the electric vacuum cleaner as shown in FIG. 18.

FIG. 20 is a cross-sectional view of the dust collection unit in the electric vacuum cleaner as shown in FIG. 18.

FIG. 21 is a perspective view of the dust collection unit in the electric vacuum cleaner as shown in FIG. 18, as viewed from anther direction.

FIG. 22 is a perspective view showing an outer shape of a dust separation unit.

FIG. 23 is a partially sectional view showing a front wall portion of a containing case, a dust separation part and a duct.

FIG. 24 is a perspective view showing an outline of a dust collection part unit.

FIG. 25 is a perspective view of the dust collection part unit shown in FIG. 24, as viewed from another direction.

FIG. 26 is a perspective view showing the dust collection part unit, with the cover removed.

FIG. 27 is a perspective view showing the cover of the dust collection part unit.

FIG. 28 is a plan view of the dust collection part unit as shown in FIG. 24.

FIG. 29 is an explanatory view showing the containing case and a discharge member.

FIG. 30 is a side view showing a pleated filter structure in another embodiment.

FIG. 31 is an explanatory view showing a shape of a cylindrical portion of the pleated filter structure as shown in FIG. 30.

FIG. 32 is a front view showing the discharge member in a dust discharge device.

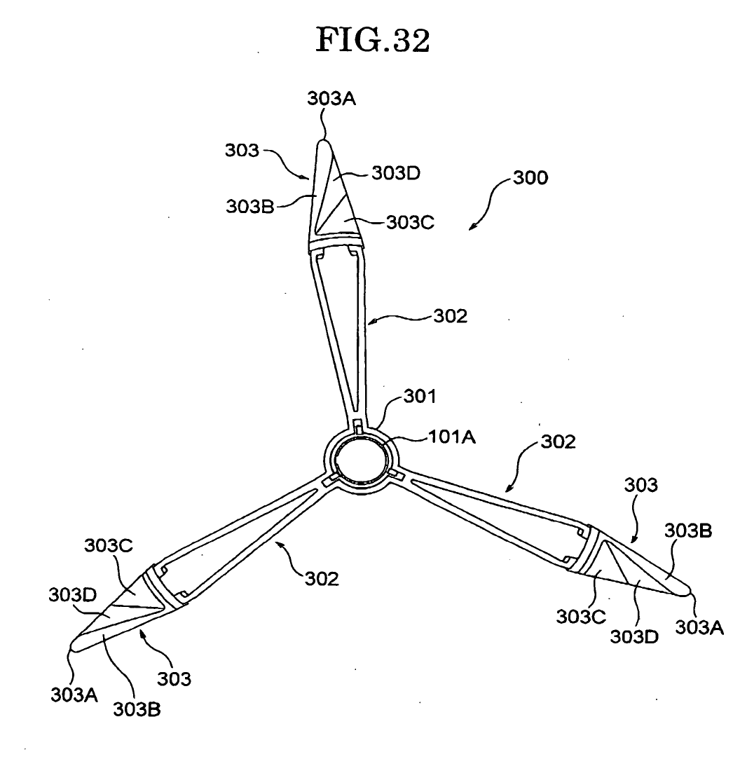

FIG. 33 is a perspective view of the dust discharge device as shown in FIG. 32.

FIG. 34 is an explanatory view showing a state where an outlet is opened by the discharge member.

FIG. 35 is a perspective view showing the dust separation part.

### DETAILED DESCRIPTION OF THE PREFERRED EMBODIMENTS

Preferred embodiments of the present invention will be explained in detail with reference to the accompanying drawings below.

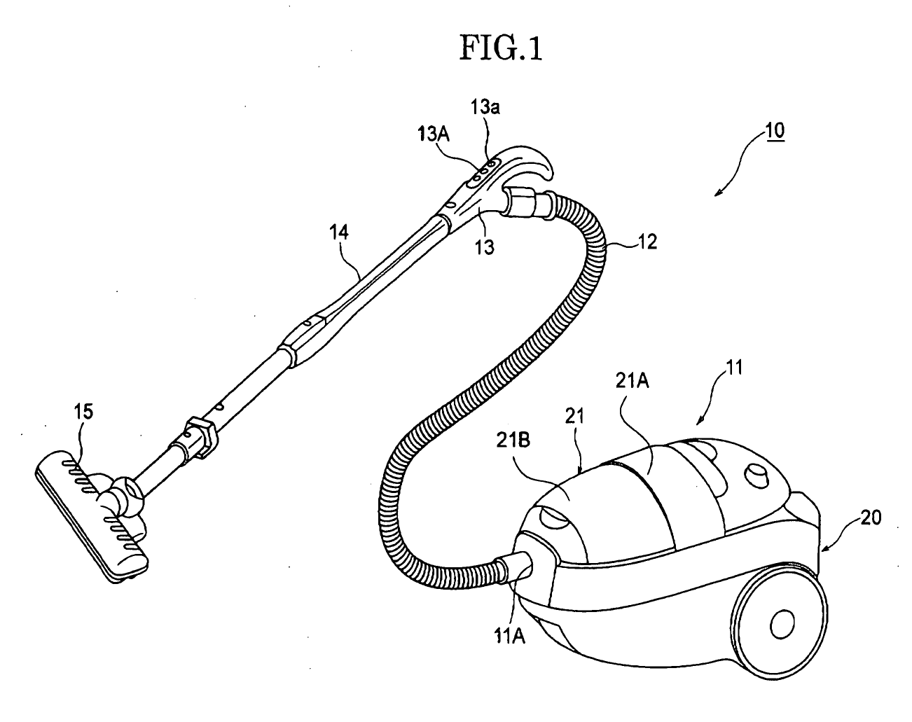

FIG. 1 illustrates an electric vacuum cleaner 10 according to a first embodiment of the present invention.

The electric vacuum cleaner 10 includes a main body 11, a dust collection hose 12 removably connected at one end thereof to a connecting port 11A of the main body 11 and provided at the other end with an operational tube 13 at hand, an extension tube 14 removably connected to the operational tube 13, and a suction body or hood 16 connected to a leading end of the extension tube 14. Provided on the operational tube 13 is an operational part 13A which is provided with a plurality of operational switches 13a.

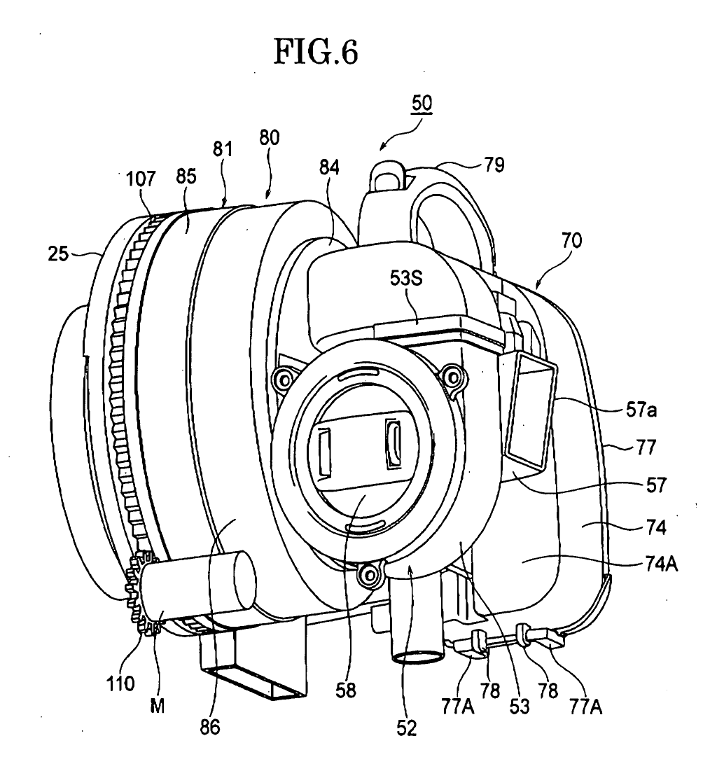

The hood 15 includes a suction chamber (not shown) having an inlet (not shown) to introduce dust on a floor or the like, which is formed in a bottom surface of the hood. The suction chamber communicates with a suction connecting port 57a of a dust collection unit 50 (see FIG. 6) provided in the main body 11 through the extension tube 14 and the dust collection hose 12.

The main body 11 includes a body case 20, an insertion opening provided in the body case and a cover 21 provided on the body case 20 to be capable of opening and closing the insertion opening. The dust collection unit 50 (see FIG. 6) removably disposed in the body case 20 through the insertion opening.

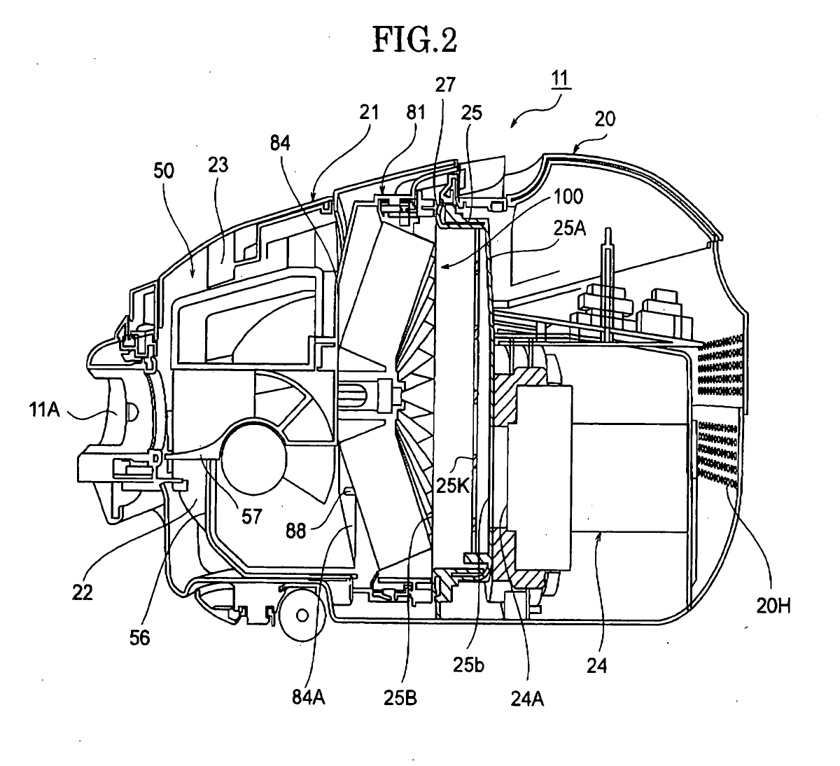

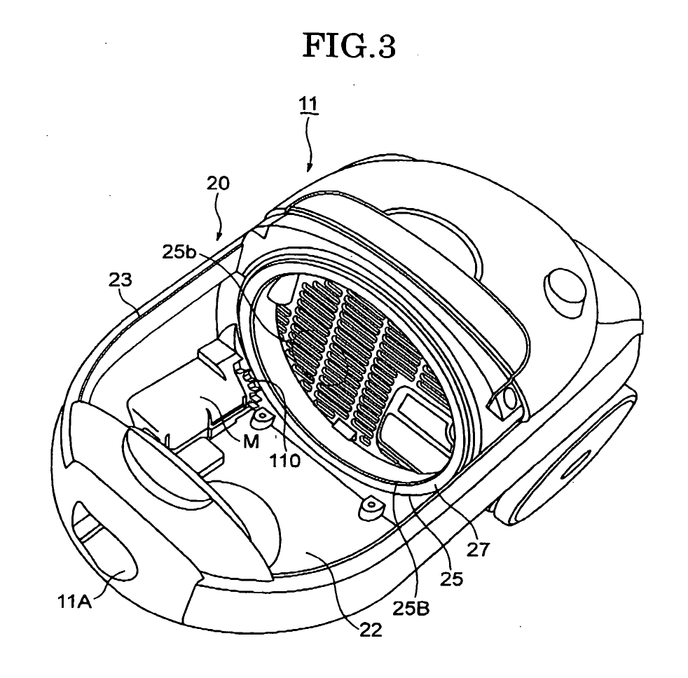

Provided in a front side of the body case 20 is a dust collection unit chamber or mounting part 22 in which the dust collection unit 50 is removably contained. The dust collection unit chamber 22 has an upper opening 23 (see FIG. 3) which is hermetically closed by the cover 21, as shown in FIG. 2.

An electric blower 24 is provided in a back side of the base case 20.

A cylindrical connecting passage 25 having a front opening 25B is provided in a front side (left side in FIG. 2) of the electric blower 24. A lattice-like member 25K is disposed in the connecting passage 25, and a sealing member 27 is attached to the front opening 25B. Formed in a back wall 25A of the connecting passage 25 is a connecting opening 25b which communicates with a suction opening 24A of the electric blower 24.

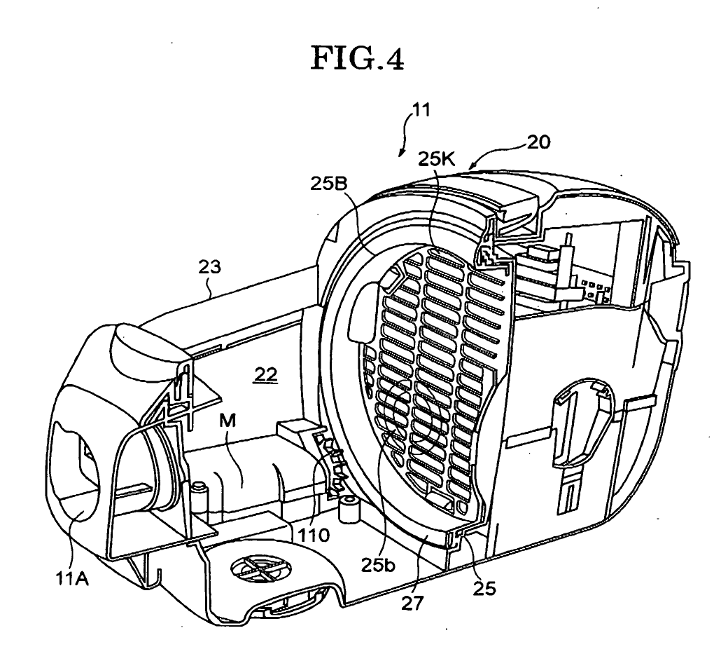

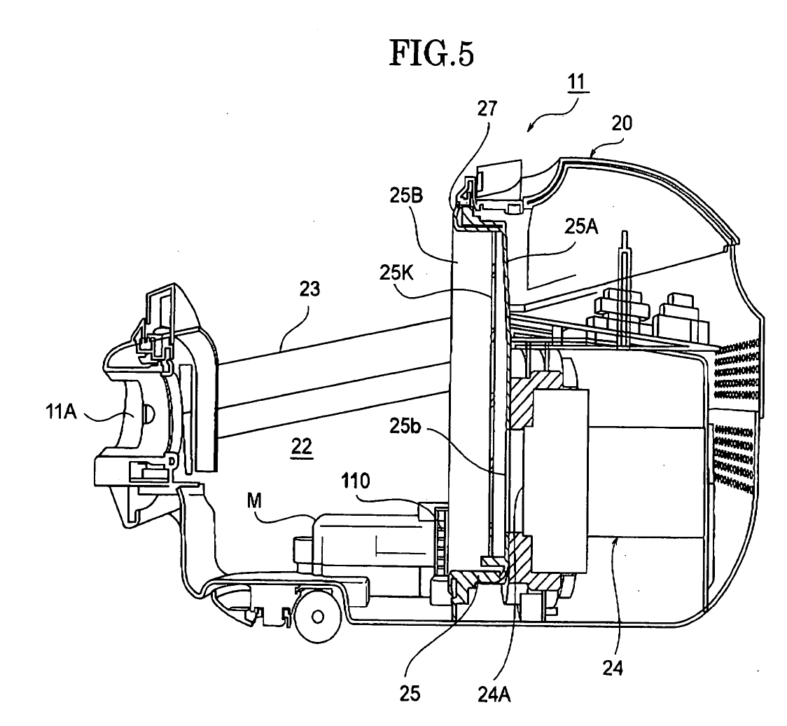

The dust collection unit chamber 22 is provided with a first transmission mechanism, for example, drive gear 110 and a drive member, for example, drive motor M to drive the drive gear 110, as shown in FIGS. 3 to 5.

The dust collection unit 50 is removably disposed in a suction air trunk between the connecting port 11A of the main body 11 and the suction opening 24A of the electric blower 24. The dust collection unit 50 can be removed out of the main body 11.

The dust collection unit 50 also includes a dust separation part 52, a dust collection part 70 removably disposed in the dust separation part 52 and a filter part 80 formed integrally with the dust separation part 52, as shown in FIGS. 6 to 8.

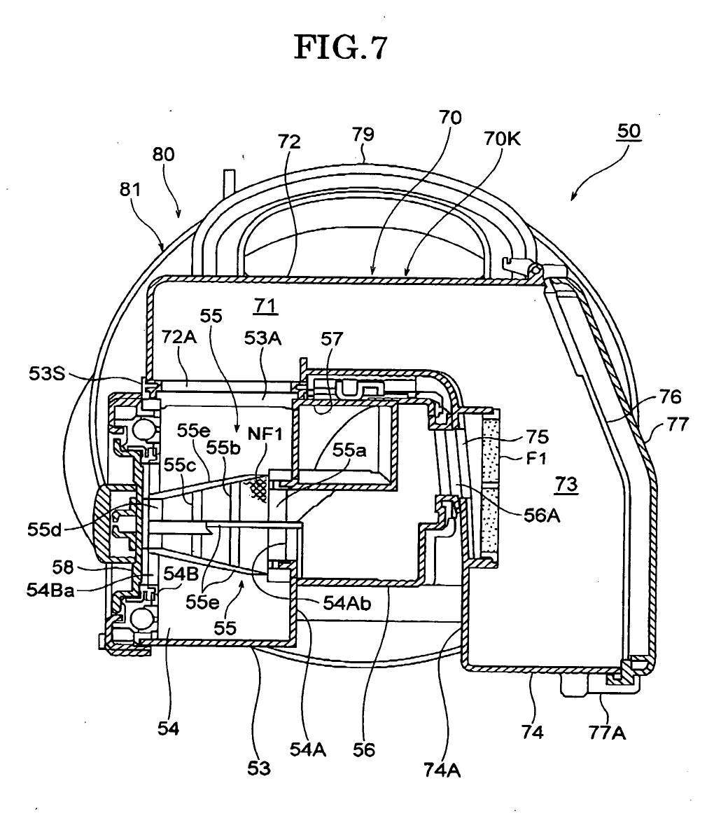

The dust separation part 52 has a cylindrical separation chamber portion 54 having a circular outer peripheral wall 53, a generally conical dust separation mechanism 55 provided in the separation chamber portion 54 along a central axis thereof, a suction passage portion 56 provided in a right side wall 54A (in FIG. 7) of the separation camber portion 54, and a guide tube 57 to guide air from the suction connecting port 57a (see FIG. 6) to the separation chamber portion 54. The suction connecting port 57a is configured to communicate with the connecting port 11A of the main body 11 when the dust collection unit 50 is disposed in the dust collection unit chamber 22 of the main body 11.

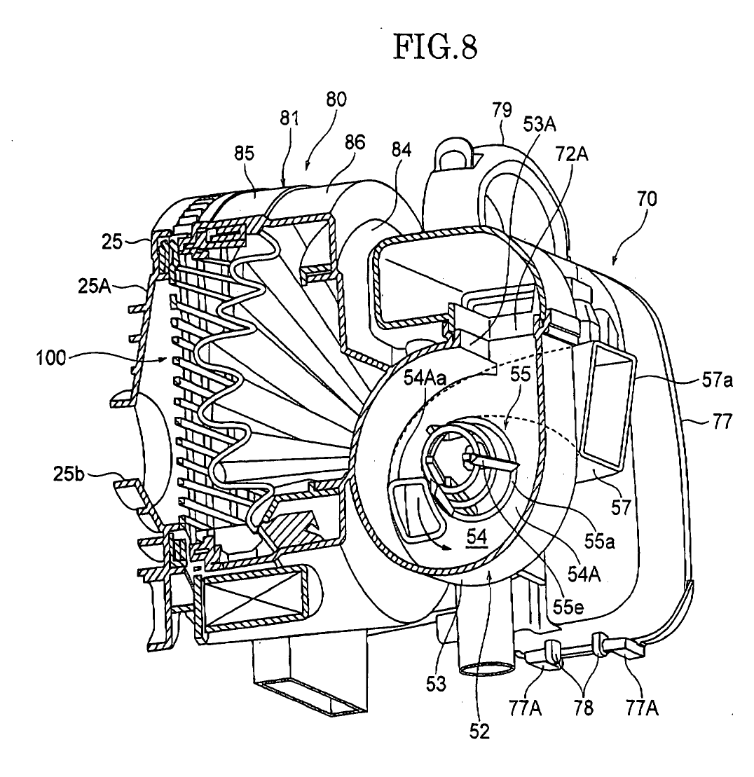

An introduction opening 53A to introduce dust separated from air is armed in an upper portion of the outer peripheral wall 53 of the separation chamber portion 54, as shown in FIGS. 7 and 8. A seal member 53S (see FIG. 6) is attached to the introduction opening 53A. In addition, a connecting port 54A (see FIG. 8) connected to the guide tube and a suction port 54Ab connected to the suction passage portion 56 are formed in the right side wall 54A (in FIG. 7) of the separation chamber portion 54.

Formed in a left side wall (in FIG. 7) of the separation chamber portion 54 is an opening 54Ba which is closed by a lid 58 which is removably attached to the separation chamber portion. The dust separation mechanism 55 is attached to the lid 58 and removed out of the separation chamber portion 54 by removing the lid 58 from the separation chamber portion.

The dust separation mechanism 55 includes a plurality of ring-shaped frames 55a to 55d having different outer diameters, a plurality of connecting frames 55e to connect the ring-shaped frames 55a to 55d and a net filter NF1 attached to circumferences of the ring-shaped frames 55a to 55d. When the lid 58 is attached to the opening 54Ba of the separation chamber portion 54, the ring-shaped frame 55a of the dust separation mechanism 55 is jointed to the suction port 54Ab of the separation chamber portion 54, thereby the suction passage 56 communicates with the separation chamber portion 54 through the suction port 54b and the net filter NF1.

The suction passage 56 communicates with a containing case 81 of a filter part 80 and a dust collection part 70 having a dust collection case 70K.

The filter part 80 and the dust collection part 70 are described hereinafter.

In addition, a connecting port 56A is formed in the suction passage portion 56.

The guide tube 57 is formed into a generally convoluted shape so that air introduced in the separation chamber portion 54 through the connecting port 54Aa of the separation chamber portion 54 is rotated counterclockwise as shown by arrow in FIG. 8.

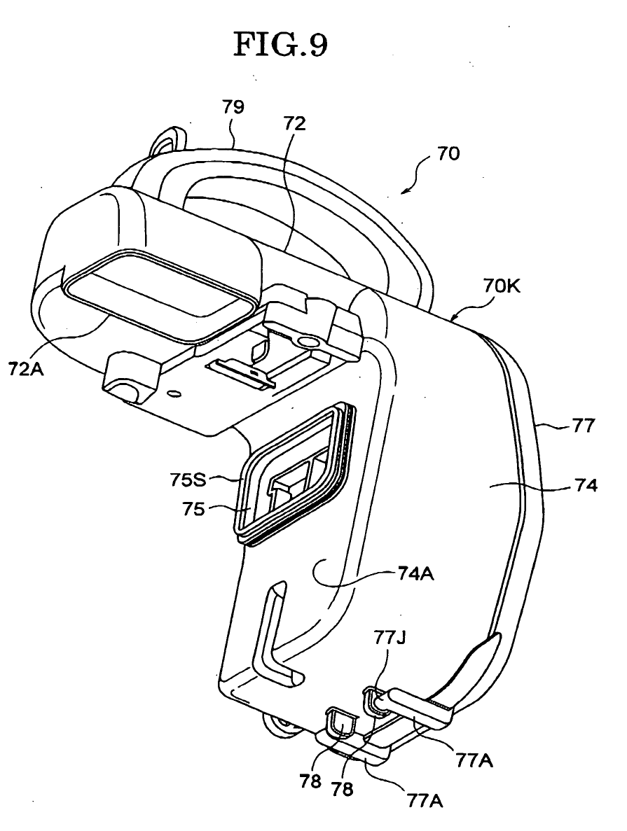

The dust collection case 70K of the dust collection part 70 is formed by a generally inverted L-character shape, as shown in FIG. 9. The dust collection case 70K includes at an upper portion thereof a communicating case portion 72 provided to form a passage 71 extending rightward and leftward as viewed in FIG. 7, and a dust collection case portion 74 extending from a right end portion of the communicating case portion 72 to a lower portion of the dust collection case 70K and configured to form a dust collection chamber 73 to collect dust.

Provided in a lower surface of the communicating case portion 72 is an opening 72A which is connected to the introduction opening 53A of the dust separation part 52, as shown in FIG. 7. The dust collection case portion has a left side wall 74A (in FIG. 9) which is provided with a connecting opening 75 having a sealing member 75S. The connecting opening 75 is connected to the connecting port 56A of the suction passage portion 56, as shown in FIG. 7. A filter F1 is provided in a position facing the connecting opening 75, as shown in FIG. 7.

An opening 76 is provided in a right side surface of the dust collection case portion 74. A cover plate 77 is attached to the opening 76 to be capable of opening and closing the opening. The cover plate 77 has at lower portions thereof arms 77A which extend leftward as viewed in FIG. 9. Provided on each of the arms 77A is a shaft 77J which is rotatably fitted in a bearing portion 78 provided on a lower portion of the dust collection case portion 74. Consequently, the opening 76 of the dust collection case portion 74 can be opened and closed by rotating the cover plate 77 about the shafts 77J. Reference number 79 shows a handle attached to the dust collection case 70K.

The filter part 80 includes a cylindrical containing case 81 which has an opened back surface (left side surface in FIG. 8) and a pleated filter structure 100 rotatably disposed in the containing case 81.

A filter dust-removal device to remove dust collected in the pleated filter structure and a dust discharge device 300 to move the removed dust from filter dust-removal device are provided. The filter dust-removal device and the dust discharge device will be described.

The above-mentioned dust separation part 52 is formed integrally with a front wall portion 84 of the containing case 81.

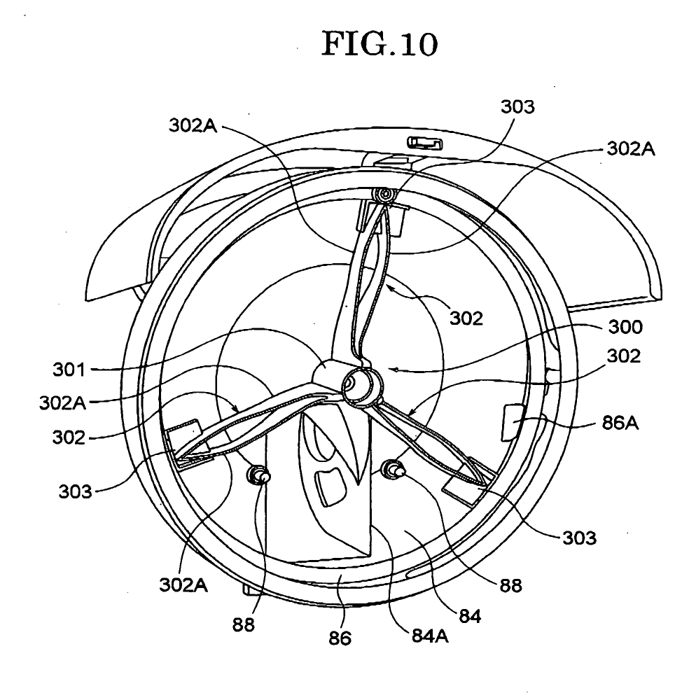

An connecting opening 84A is provided in the front wall portion 84 of the containing case 81, as shown in FIG. 10 and is connected to the suction passage portion 56 (see FIG. 7). The containing case 81 communicates with the suction passage portion 56 through the connecting opening 84A.

The filter dust-removal device includes a removing member. The removing member comprises, for example, a pair of protrusions 88 which are provided on the front wall portion 84 to extend backwardly and be disposed across the connecting opening 84A. The pair of protrusions 88 are contactable with mountains 104A of a pleated filter 104 (described hereinafter) of the pleated filter structure 100 and disposed downwardly of a rotational center of the pleated filter structure 100.

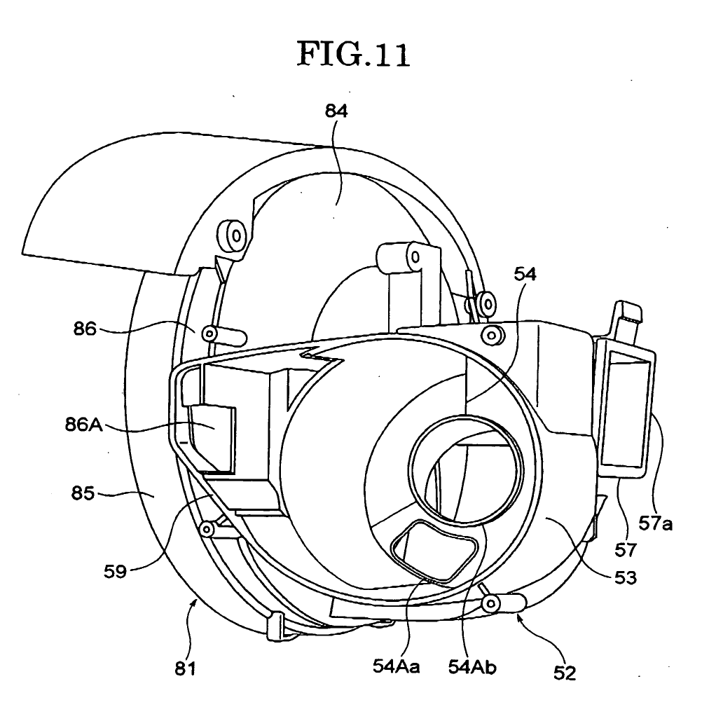

The containing case 81 includes a cylindrical holding portion 85 to rotatably hold the pleated filter structure 100 and a cylindrical dust receiving part 86 to receive dust removed from the pleated filter structure 100, as shown in FIGS. 6 and 8. An outlet 86A to discharge the dust contained in the dust receiving part 86 is formed in the from wall portion of the dust receiving part 86, as shown in FIGS. 10 and 11. The outlet 86 communicates with the separation chamber portion 54 of the dust separation part 52 through a communication passage 59.

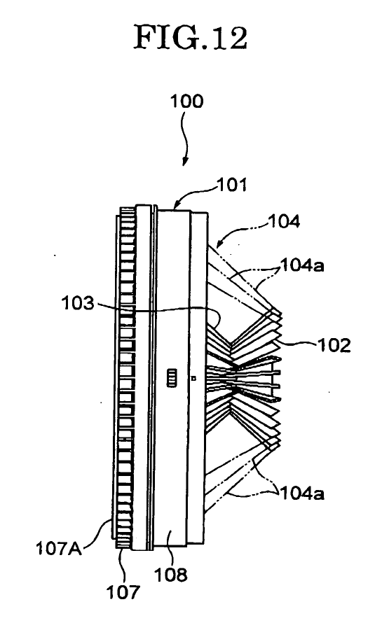

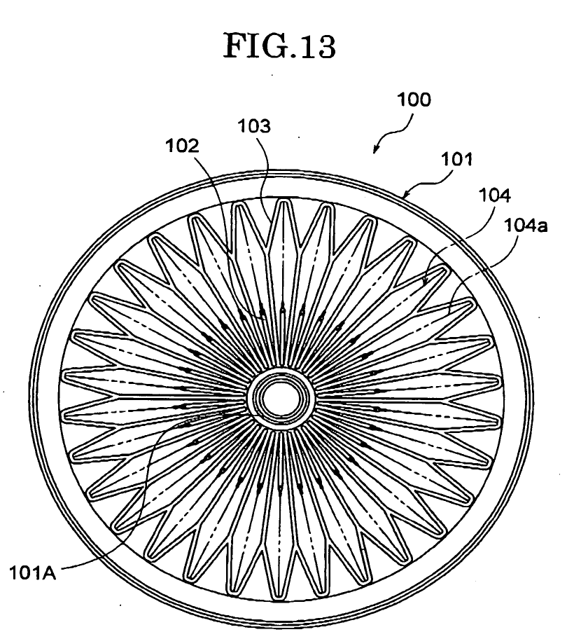

The pleated filter structure 100 includes a cylindrical frame 101, a shaft 101A provided at a central position of the cylindrical frame 101, a plurality of ribs 102 and 103 to form pleats radially extending from the shaft 101A and a pleated filter 104 attached to the plurality of ribs 102 and 103, as shown in FIGS. 12 and 13. Reference number 104a shows the above-mentioned mountains of the pleated filter structure 100. The mountains are disposed to face an upstream of air including dust.

In one embodiment, the dust discharge device 300 comprises a discharge or blade structure and is rotated together with the pleated filter structure 100. The blade structure 300 includes a tubular portion 301 in which the shaft 101A of the pleated filter structure 100 is fixedly fitted, for example, three arms 302 radially extending from the tubular portion 301 and a discharge member, sweeping out member or blade provided on a leading end of each of the arms 302, as shown in FIG-10. Each of the arms 302 is formed by two-forked arm members 302.

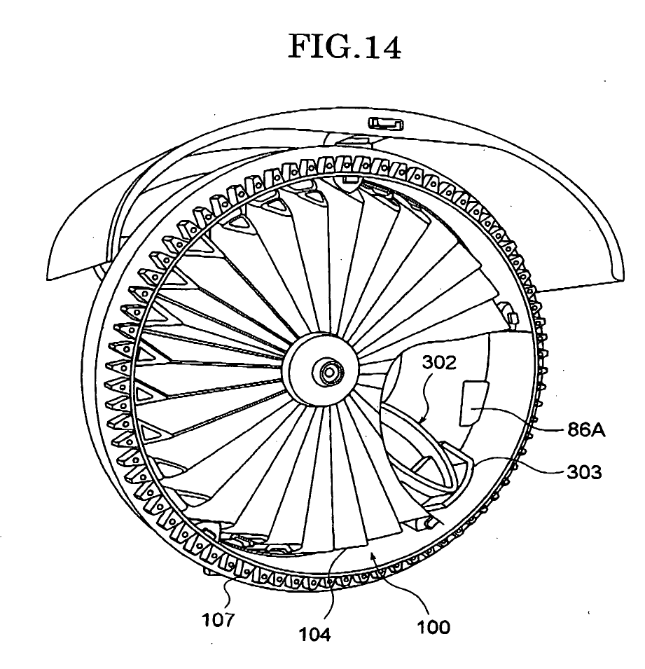

The blade structure 300 is disposed adjacently to the pleated filter structure 100 by fitting the shaft 101A of the pleated filter structure 100 in the tubular portion 301 of the blade structure 300 as shown in FIG. 14 to rotate together with the pleated filter structure 100.

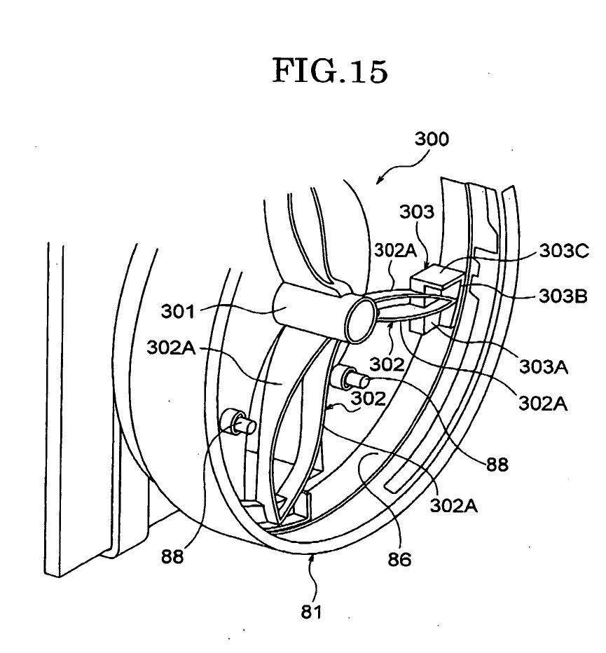

Each of the blades 303 is capable of sliding on an inner wall surface of the dust receiving part 86 of the containing case 81 and includes a flat portion 303A attached to the arm 302, a circular-arc sliding portion 303B attached to the flat portion 303A and disposed to be in contact with the inner wall surface of the dust receiving part 86, and a sweeping-out portion or discharge portion 303C attached to the flat portion 303A and configured to discharge the dust contained in the dust receiving part 86 to the outlet 86A, as shown in FIG. 15.

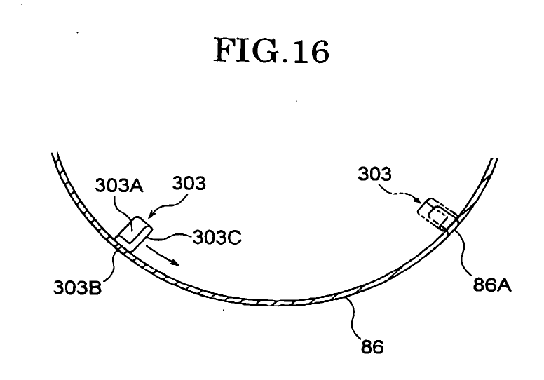

Each blade 303 slides on the inner wall surface of the dust contained in the dust receiving part 86 of the containing case 81 when the pleated filter structure is rotated, as shown in FIG. 16, thereby the blade discharges the dust accumulated on the inner wall surface of the dust receiving part 86 to the outlet 86A. The dust ejected from the outlet 86A is adapted to transported through the communication passage 59 (see FIG. 11) into the separation chamber portion 54 of the dust separation part 52.

A closing mechanism to close the outlet when the dust is discharged from the outlet is provided. The closing mechanism includes a closing member configured to close the outlet when the dust in the dust receiving part is discharged from the outlet 86A. In one embodiment, the closing member is formed by the blade 303. More specifically, when the pleated filter structure 100 is rotated and the blade 303 comes to a position shown by chain line in FIG. 16, the flat portion 303A and the sliding portion 303B of the blade 303 close the outlet 86A.

Generally, the blade 303 is configured to close the outlet 86A.

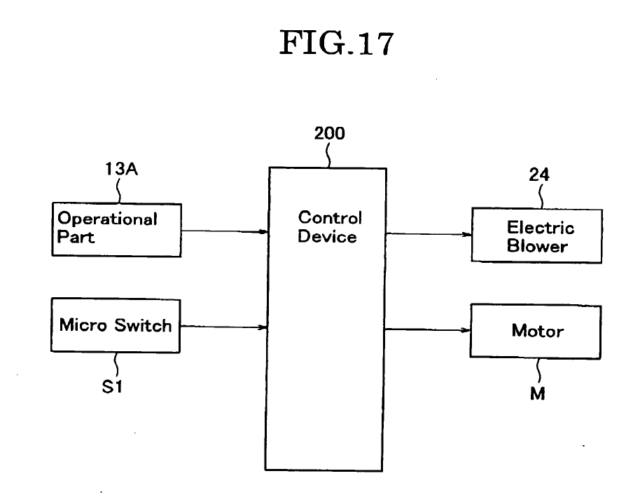

When each blade 303 comes to a position to close the outlet 86A, a positional detecting device, for example, a micro switch S1 (see FIG. 17) detects the position and a drive mechanism, for example, the motor M to drive the dust discharge device is stopped. Here, the micro switch S1 is disposed in and attached to the containing case 81.

As shown in FIG. 12, the frame 101 includes a cylindrical sliding portion 108 rotatably held in the holding portion 85 of the containing case 81 and a cylindrical gear portion 107A formed on a left end (in FIG. 12) of the sliding portion 108. On an outer peripheral of the gear portion 107A is a gear 107 which acts as a second transmission section. The gear portion 107A is disposed to project out of the holding portion 85 of the containing case 81 to expose the gear 107 form the containing case 81, as shown in FIG. 6.

The gear 107 engages with the drive gear 110 provided in the dust collection unit chamber 22 of the main body 11 and the pleated filter structure 100 is rotated in the containing case 81 by rotation of the drive motor M.

The drive gear 110 is disposed downwardly of the rotational center of the gear 107 or the rotational axis of the pleated filter 104, as shown in FIG. 6. In other words, the drive gear 110 is disposed opposite to the dust collection unit 50 relative to the rotational center of the gear 107. Moreover, the dust collection unit 50 is mounted upwardly and downwardly relative to the dust collection unit 22 of the main body 11 and is set to be perpendicular to the rotational axis of the gear 107.

When the dust collection unit 50 is mounted on the dust collection unit chamber 22 of the main body 11, the gear 107 is engaged with the drive gear 110. When the dust collection unit 50 is lifted from the dust collection unit chamber 22, the gear 107 is disengaged with the drive gear 110 so that the dust collection unit 50 can easily be removed from the dust collection unit chamber 22.

In addition, when the dust collection unit 50 is mounted on the dust collection unit chamber 22 of the main body 11, an end surface of the gear portion 107A is jointed to the front opening 26B of the connecting passage 25 of the main body 11 through the seal member 27 to communicate the connecting passage 25 with the containing case 81 of the dust collection unit 50.

FIG. 17 illustrates one example of a control system for the electric vacuum cleaner.

In FIG. 17, reference number 200 shows a control device which controls the electric blower 24, the motor M and so on, based on operation of the operational switches 13a (see FIG. 1) of the operational part 13A or a detection signal of the micro switch S1.

Next, operation of the electric vacuum cleaner structured as mentioned above is explained.

As shown in FIG. 2, the dust collection unit 50 is first mounted on the dust collection unit chamber 22, and one end of the dust collection hose 12 is connected to the connection port 11A of the main body 11 and another end of the dust collection hose 12 is connected to the hood 15 through the extension tube 14.

A power plug (not shown) is connected in a plug outlet. At this time, when the micro switch S1 does not detect the blade 303 of the dust discharge device 300, in other words, the blade 303 does not close the outlet 86A of the dust receiving part 86, the motor M is driven to rotate the pleated filter structure 100 of the filter part 80. The blades 303 of the dust discharge device 300 are moved to slide on the inner wall surface of the dust receiving part 86 depending on the rotation of the pleated filter structure 100. When one of the blades 303 is disposed in a position closing the outlet 86A of the dust receiving part 86, the micro switch S1 detects the blade 303 to stop the drive of the motor M by the control device 200.

While the blades 303 are moved in the dust receiving part 86, the dust accumulated in the dust receiving part 86 is moved to outlet 86A, discharged out of the outlet 86A, and moved from the outlet 86A through the communication passage 59 into the separation chamber portion 54 of the dust separation part 52.

During the drive of the motor M, in other words, while each of the blades 303 moves to a position closing the outlet 86A, even if the operational switches 13a of the operational part 13 are operated, the electric blower 24 is not driven. Thereby, the dust ejected to the separation chamber portion 54 of the dust separation part 52 is prevented from being sucked through the outlet 86A and attached to the pleated filter 104 again.

When the micro switch S1 of the dust collection unit 50 detects the blades 303 of the pleated filter structure 100, in other words, one of the blades 303 closes the outlet 86A of the dust receiving part 86A, if one of the operational switches 13a of the operational part 13 is operated, the electric blower 25 in driven.

By the drive of the electric blower 24, air is vacuumed from the suction opening 24A of the electric blower 24 to generate a negative pressure in the containing case 81 of the dust collection unit 50 through the connecting passage 25 and in the dust collection case 70K and the suction chamber portion 54 of the dust separation part 52 through the suction passage portion 56. The negative pressure operates in the dust collection hose 12, the extension tube 14 and the hood 15 through the guide tube 57, thereby the dust together with air is sucked into the hood 15.

The sucked dust and air are moved to be sucked into the suction connecting port 57a of the dust collection unit 50 through the extension tube 14 and the dust collection hose 12. The dust and the air sucked into the suction connecting port 57a are introduced in the separation chamber portion 54 of the dust separation part 52 through the guide tube 57 and rotated counterclockwise in the separation chamber portion 54, as shown in FIG. 8. By the rotation of the dust and the air, a part of the air is separated from the dust, the separated air passes through the net filter NF1 of the dust separation mechanism 55 as shown in FIG. 7, further passes the suction passage portion 56 to be sucked into the containing case 81 of the filter part 80.

On the other hand, dust and air which are not separated are introduced from the introduction opening 53A of the separation chamber portion 54 into the communication case portion 72 of the dust collection part 70 by rotation of the dust and the air. The introduced dust and air are sucked through the passage 71 of the communication case portion 72 into the dust collection chamber 73 to collect the dust in the dust colon chamber 73.

The air sucked in the dust collection chamber 73 is sucked through the filter F1 and the connecting opening 75 to the suction passage portion 25 of the main body 11, further sucked into the containing case 81 of the filter part 80.

The air sucked in the containing case 81 is sucked through the pleated filter 104 of the pleated filter structure 100 into the connecting passage 25 of the main body 11, further sucked in the suction opening 24A of the electric blower 24.

Because each of the blades 303 of the dust discharge device 300 closes the outlet 86A of the dust receiving part 86 of the containing case 81, when sucking the dust in the separation chamber portion 54 of the dust separation part 52 through the communication passage 59 from the outlet 86A, the dust is prevented from being attached to the pleated filter 104 again.

The air sucked to the suction opening 24 A of the electric blower 24 is exhausted from an exhaust port 20H provided in the main body 11 as shown in FIG. 2 through the electric blower 24.

If the cleaning is completed, the drive of the electric blower 24 is not stopped by operation of one of the operational switches 13a of the operational part 13A. When the electric blower 24 is stopped, the control device 200 as shown in FIG. 17 is configured to drive the motor M. The rotation of the motor M causes the drive gear 110 to rotate, whereby rotating the pleated filter structure 100.

By the rotation of the pleated filter structure 100, the protrusions 88 provided on the front wall portion 84 of the containing case 81 abut with the mountains and go over the mountains depending on the rotation of the pleated filter structure 100. Vibrations are imparted to the pleated filter 104 every the protrusions 88 go over the mountains, thereby the dust attached to the pleated filter 104 is removed. The removed dust is accumulated in the dust receiving part 86 of the containing case 81.

Because the protrusions 88 are provided downwardly of the rotational center of the pleated filter structure 100, a large force is imparted to a lower portion of the pleated filter 104. Therefore, dust on the lower portion of the pleated filter 104 is removed from the lower portion and drops to the dust receiving part 86 directly. It should be noted that the removed dust is efficiently dropped into the dust receiving part 86 without being attached to the pleated filter 104 again during the drop.

On the other hand, the dust discharge device 300 rotates together with the pleated filter structure 100 and the blades 303 of the dust discharge device 300 slide on the inner wall surface of the dust receiving part 86 of the containing case 81, as shown in FIG. 16. With the sliding of the blades 303, the dust accumulated in the dust receiving part 86 is moved along the inner wall surface to be discharged from the outlet 86A of the dust receiving part 86. The dust discharged from the outlet 86A is supplied through the communication passage 59 into the separation chamber portion 54 of the dust separation part 52.

When one of the blades 303 comes in a position closing the outlet 86A of the dust receiving part 86 as shown by chain line in FIG. 16 by the pleated filter structure 100 being rotated, for example, one revolution, the micro switch S1 detects the blade 303 and the control device 200 controls the motor M to stop it. Thereby, the rotation of the pleated filter structure 100 is stopped in the position where the blade 303 closes the outlet 86A of the dust receiving part 86.

In this embodiment, because the three blades 303 are provided, every the micro switch S1 detects each of the three blades 303, the motor M is stopped. Before the blade 303 comes to a position closing the outlet 86A, even if one of the operational switches 13a of the operational part 13A is operated again, the control device 200 does not drive the electric blower 24. Thereby, the dust entered the separation chamber portion 54 of the dust separation part 52 is prevented from returning through the outlet 86A to the dust receiving part 86 and being attached to the pleated filter 104 again.

In addition, if the power plug is removed from the plug outlet before the blade 303 comes to a potion closing the outlet 86A, the drive of the motor M is stopped before the blade 303 closes the outlet 86A, thereby the outlet 86A is not closed by the blade 303. However, if the power plug is connected to the plug outlet, the motor M is driven to rotate the pleated filter structure 100 as mentioned above, thereby the output 86A is closed by the blade 303, thereafter, the electric blower 24 is driven, therefore a problem that the dust ejected to the separation chamber portion 54 of the dust separation part 52 is sucked through the outlet 86A can be prevented.

For use throughout a long period, if the pleated filter is clogged with dust, the pleated filter can be cleaned.

To execute the cleaning, the cover 21 of the main body 11 is first opened and the dust collection unit 50 is lifted. By the lifting of the dust collection unit, the gear 107 of the pleated filter structure 100 is removed from the drive gear 110 without it being interfered by the drive gear 110 because the drive gear 110 is disposed downwardly of the rotational center of the gear 107 of the pleated filter structure 100. Therefore, the dust collection unit 50 can easily be removed from the dust collection unit chamber 22 of the main body 11.

After the dust collection unit 50 is removed from the dust collection unit chamber 22, the pleated filter 104 of the pleated filter structure 100 in the dust collection unit 50 is cleaned. In this case, the dust collection part 70 may be removed.

After the cleaning of the pleated filter 104 is completed, if the cleaned duct collection unit 60 is inserted in the dust collection unit chamber 22 of the main body from above, the gear 107 of the pleated filter structure 100 engages with the drive gear 110 and the dust collection unit 50 is mounted on the dust collection unit chamber 22, without the dust collection unit being interfered by the drive gear 110 because the drive gear 110 is disposed downwardly of the rotational center of the gear 107 of the pleated filter structure 100.

In this way, because the dust collection unit 50 can be mounted on the dust collection unit chamber 22 only by inserting the dust collection unit 50 into the dust collection unit chamber 22 from above, the mounting of the dust collection unit is very easy.

When throwing away the dust accumulated in the dust collection part 70, because it is not required to remove the dust collection unit 50, only the dust collection part 70 may be removed from the dust collection unit 50 by opening the cover 21 of the main body 11. Thereby, the dust accumulated in the dust collection chamber 73 can be thrown away by opening the cover plate 77 of the dust collection part 70.

Although the above-mentioned embodiment has been applied to a canister type-electric vacuum cleaner, it can be applied to an upright type-electric vacuum cleaner.

Next, a second embodiment of the electric vacuum cleaner according to the present invention is described.

In the second embodiment, a dust separation unit 400 and a dust collection part unit 410 which are described hereinafter are removably mounted on a dust collection unit 22.

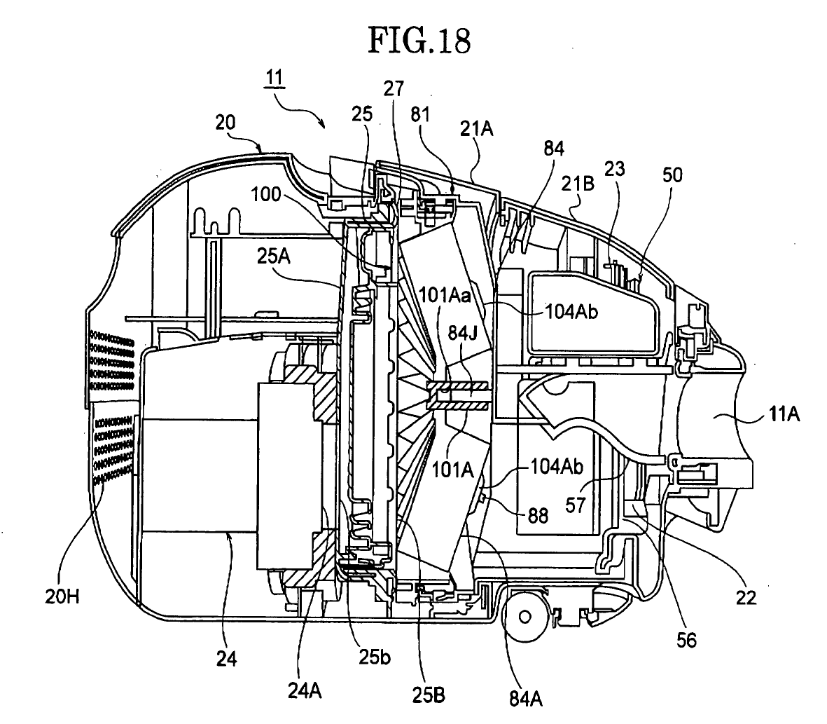

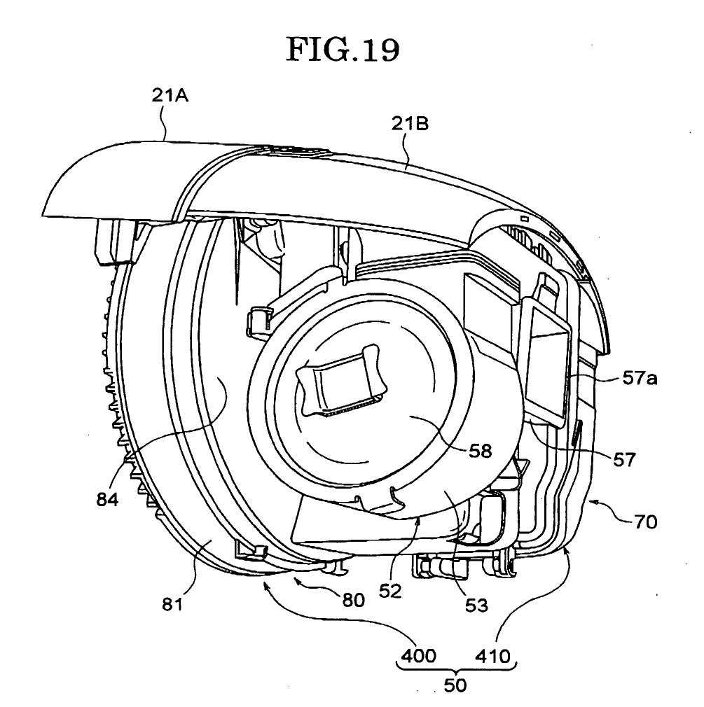

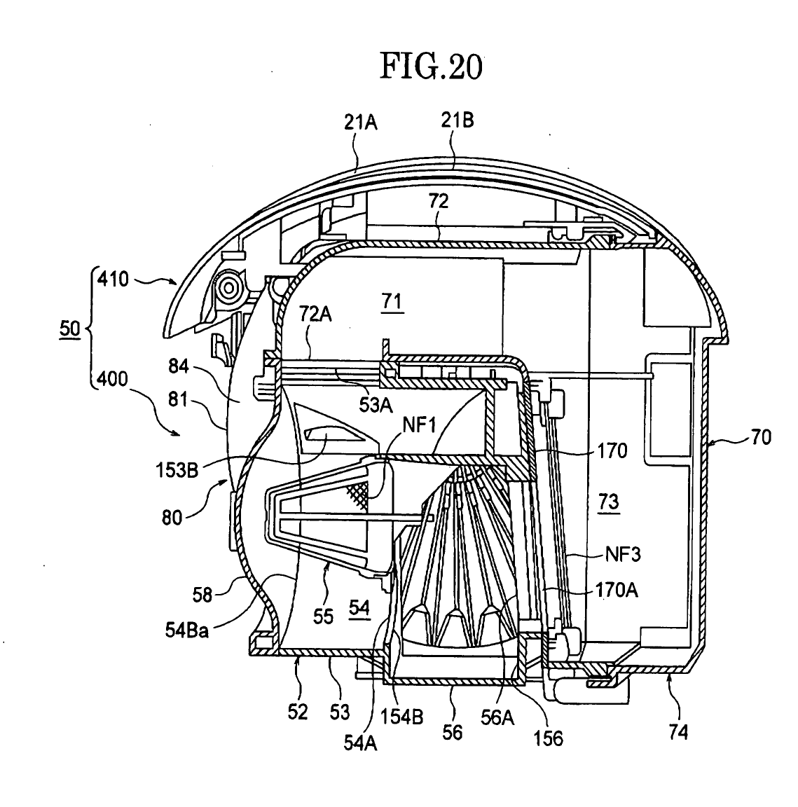

The dust separation unit 400 includes a dust separation part or first separation part 52, a filter part 80 formed integrally with the dust separation part 52, and a cover case 21 provided on the filter part 80, as shown in FIGS. 18 and 19. The dust collection part unit 410 includes a dust collection part 70 and cover cases 21A, 21B provided on the dust collection part 70 (see FIGS. 19 and 20).

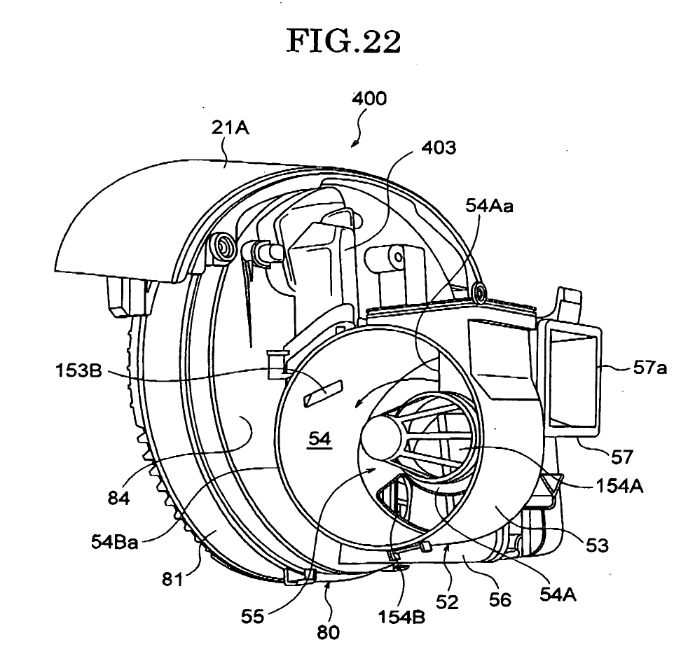

The dust separation part 52 includes a separation chamber portion 54 which is formed in a circular shape by an outer peripheral wall 53, a dust separation device 55 which has a generally conical shape and is provided in the separation chamber portion 54 along an axis of the separation chamber portion 54, a suction air trunk 56 provided in an outer side of a right side wall 54A (see FIG. 22) of the separation chamber portion 54, and an air guide tube 57 to guide air from a suction connecting port 57a (see FIG. 19). The suction connecting port 57a is configured to communicate with the connecting port 11A of the main body 11 when the dust separation unit 400 is mounted on the dust collection unit chamber 22.

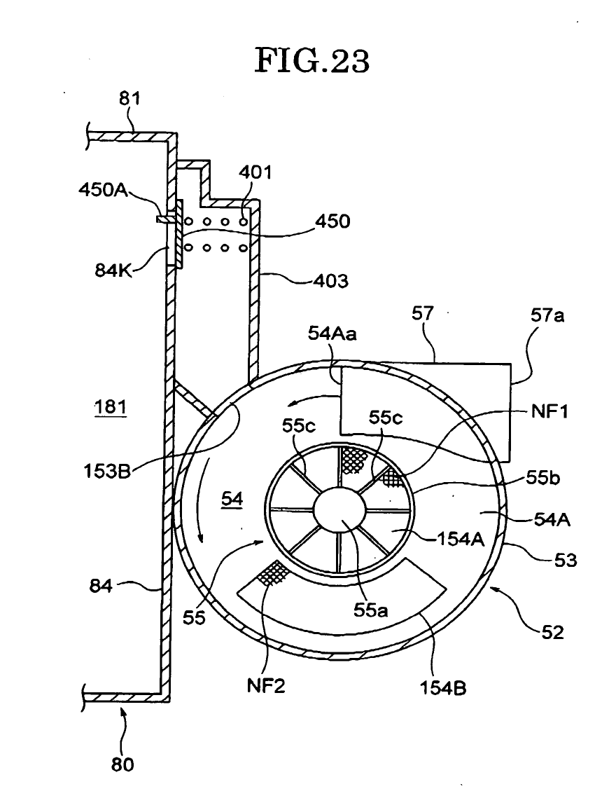

An introduction opening 53A to introduce dust separated from air into the dust collection part 70 and an introduction port 153B to introduce dust ejected from an outlet 84K (see FIG. 23) as described hereinafter into the separation chamber portion 54 are formed on the outer peripheral wall 53, as shown in FIG. 20.

A circular opening 154A and a sector opening 154B am formed in the right side wall 54A of the separation chamber portion 54, as shown in FIGS. 22 and 23. The dust separation device 55 is attached to the opening 154 and a net filter NF2 is attached to the opening 154B. Provided in the right side wall 54A is a connecting opening 54Aa which is connected to the air guide tube 57 to communicate the separation chamber portion 54 with the air guide tube 57.

A right side surface (in FIG. 20) of the separation chamber portion 54 is opened as shown by an opening 54Ba (see FIG. 22) to which a cover 68 (see FIG. 23) is removably attached.

As shown in FIG. 23, the dust separation device 55 includes a disc 55a, a ring-like frame 55b, a plurality of connecting frames 55c to connect the disc 55a and the ring-like frame 55b, and a net filter NF1 attached to circumferences of the connecting frames 55c. The suction air trunk 56 communicates with the separation chamber portion 54 through the opening 154A of the right side wall 54A and the net filter NF1 and with the separation chamber portion 54 through the net filter NF2 of the opening 154B of the right side wall 54A.

The suction air trunk 56 communicates with a containing case 81 of the filter part 80 as described hereinafter and with a dust collection chamber 73 of a dust collection case portion 74 as described hereinafter through the connecting opening 56A formed in a right side wall portion 156 (see FIG. 20). The dust collection chamber 73 is configured to collect dust.

The guide tube 57 is configured to rotate air introduced from the connecting opening 54Aa of the separation chamber portion 54 into the separation chamber portion 54 counterclockwise as shown by arrow in FIGS. 22 and 23.

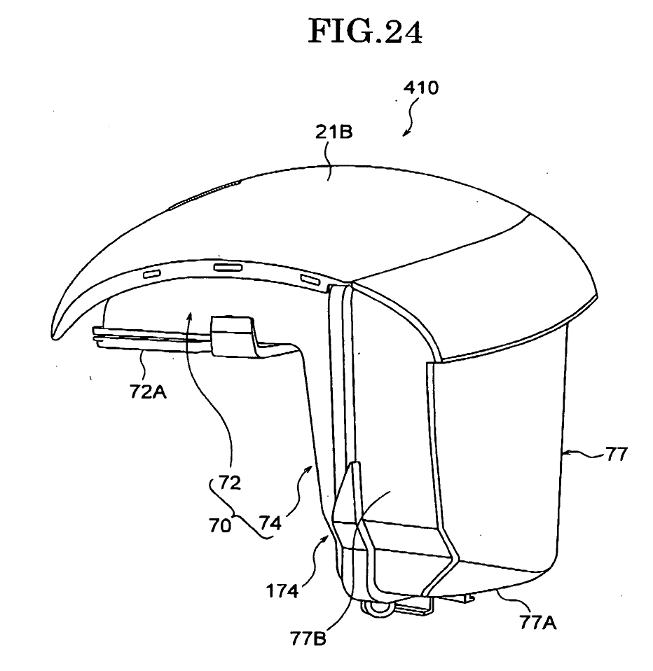

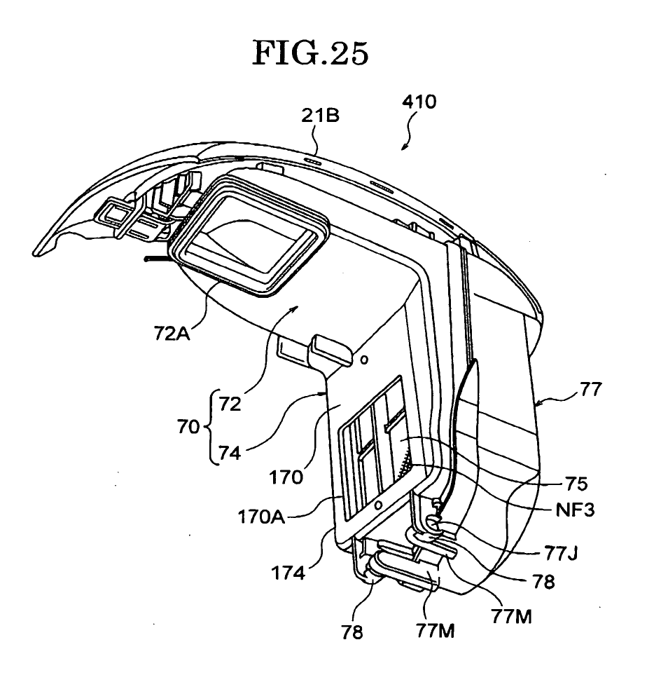

The dust collection part 70 includes a communication case portion 72 having a communication passage 71 (see FIG. 20) which is provided to extend rightward and leftward in an upper portion of the communication case portion 72, as shown in FIGS. 24 and 25. The dust collection case portion 74 extends from a right end portion of the communication case portion 72 downwardly.

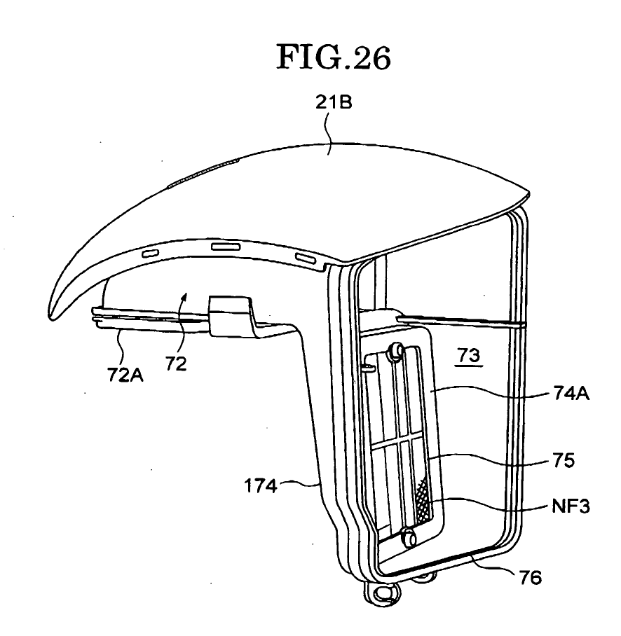

Formed in a lower surface of the communication case portion 72 is an opening 72A which is connected to the introduction opening 53A of the dust separation part 52, as shown in FIG. 20. Moreover, a connecting opening 75 is formed in a left side wall portion 74A of the dust collection case portion 74 as shown in FIG. 26, and a net filter NF3 is attached to the connecting opening 75.

A cover plate 170 is attached to an outer wall portion of the dust collection portion 74 in an outer side of the net filter NF3 and at a potion remote form the net filter NF3 a predetermined interval (see FIG. 20). An opening 170A is formed in a lower portion of the cover plate 170 and covered by the cover plate 170 from a position facing an upper portion of the net filter NF3.

The opening 170A of the cover plate 170 is connected to the connecting opening 56A of the suction air trunk 56, as shown in FIG. 20.

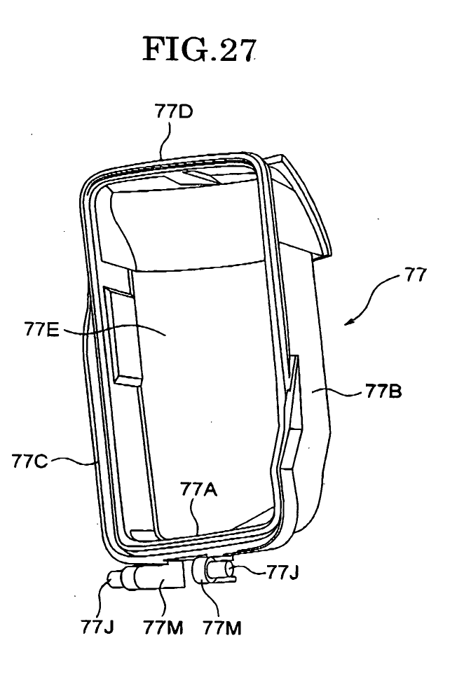

The dust collection case portion 74 includes a case portion 174 which has an opened right side surface as shown at 76 (see FIG. 26), and a cover 77 (see FIG. 27) which is removably attached to the opening 76 of the case portion 174.

Arm portions 77M extending in a left direction as shown in FIG. 25 are formed on a bottom wall portion 77A of the cover 77. As shown in FIG. 27, each of the arm portions 77M has a shaft 77J which is rotatably held in a bearing portion 78 provided on a bottom portion of the dust collection case portion 74. By rotating the cover 77 about the shafts 77J, the opening 76 of the dust collection case portion 74 is opened and closed.

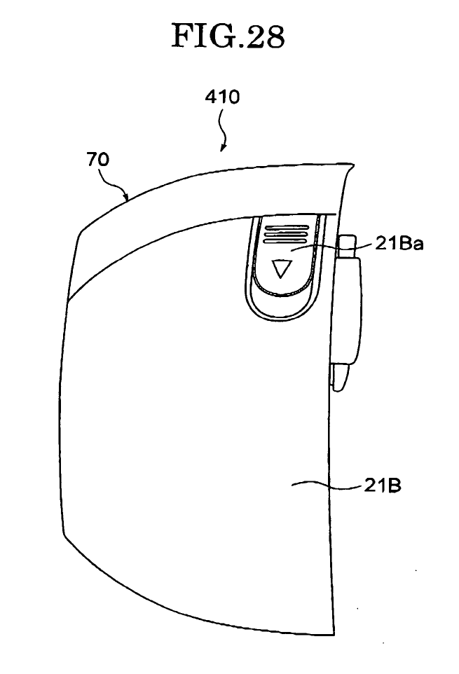

Formed on an upper portion of the cover 77 is a hook (not shown) which is engaged with an engagement portion (not shown) of the dust collection case portion 74, thereby the over 77 is not opened. As shown in FIG. 28, when a release button 21Ba provided on the a cover case 21B of the dust collection part 70 is operated, the hook is disengaged and if the cover 77 is positioned downwardly, the cover 77 is rotated about shafts 77J by a self weight to open the opening 76.

The cover 77 includes a bottom wall portion 77A, side wall portions 77B, 77C formed on opposite sides of the bottom wall portion 77A, an upper wall portion 77D provided on upper portions of the side wall portions 77B, 77C, and a cover portion 77E surrounded by the bottom wall portion 77A, the side wall portions 77B, 77C, and the upper wall portion 77D. The case portion 174 and the cover 77 are configured to divide the dust collection case portion 74 into two upwardly and downwardly, a width of the side wall portion 77B of the cover 77 is set to be ½ more of a width of the side portion of the dust collection case portion 74.

When the dust collection part unit 410 is mounted on the dust collection unit chamber 22 of the main body 11, on which the dust separation unit 400 is mounted, as shown in FIG. 20, the introduction opening 53A of the dust separation part 52 is connected to the opening 72A of the dust collection part unit 410, and the opening 170A of the cover 170 of the dust collection part unit 410 is connected to the connecting opening 56A of the suction air trunk 56 of the dust separation unit 400.

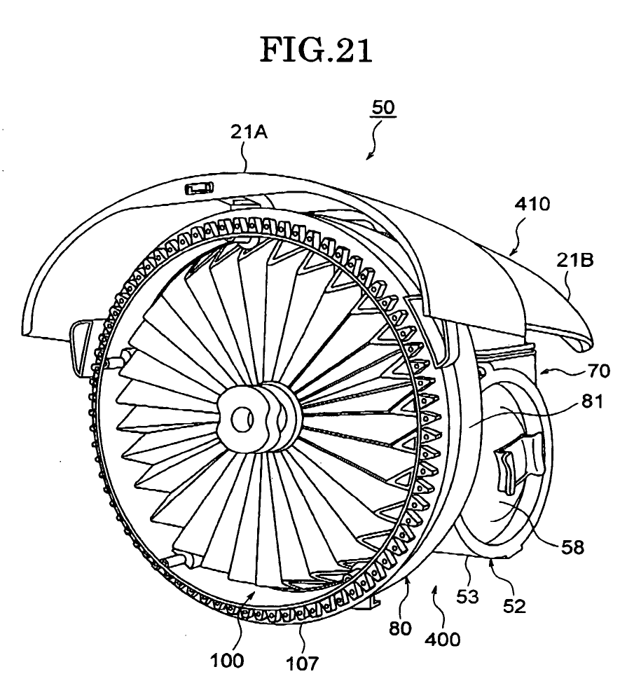

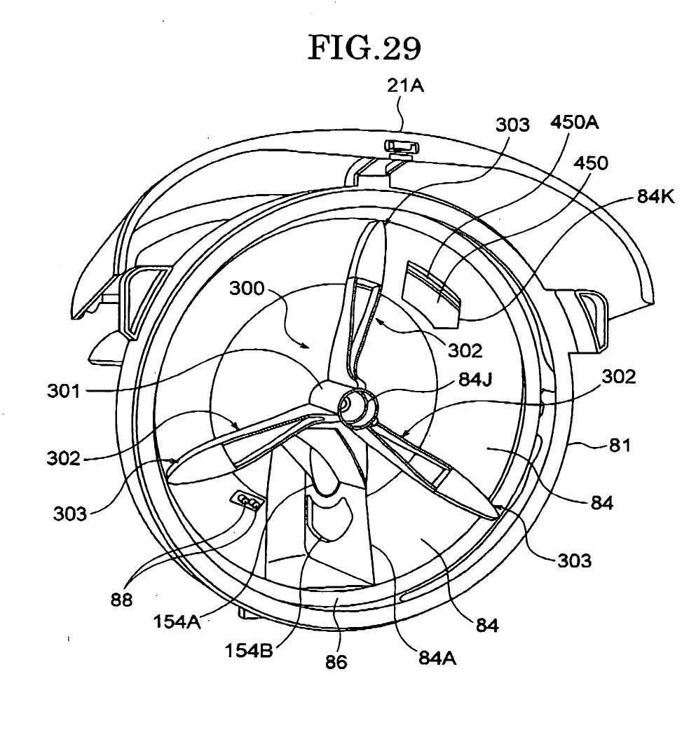

The filter part 80 has a back surface (left side surface in FIG. 21) which is opened and includes a cylindrical containing case 81, a pleated filter structure 100 (secondary filter section) rotatably provided in the containing case 81, and a sweep-out device or dust discharge device 300 configured to rotate together with the pleated filter structure 100 (see FIG. 29). The dust separation part 52 is formed on a front surface (right side in FIG. 19) of a front wall portion or sectioned wall 84 of the containing case 81. The containing case 81 is configured to form a filter chamber 181 (see FIG. 23).

Formed in the front wall portion 84 of the containing case 81 are a connecting opening 84A and an outlet 84K provided in an upper portion of the front wall portion and configured to discharge dust, as shown in FIG. 29. The connecting opening 84A is connected to the suction air trunk 56 (see FIG. 20). The suction air trunk 56 communicates with the containing case 81 through the connecting opening 84A.

The outlet 84K is closed by a closing cover 450 as shown in FIG. 23, the closing cover 450 is biased by a spring 401 backwardly (left direction in FIG. 23). Also, the closing cover 450 is capable of moving forwardly (right direction) against a biasing force of the spring 401. The forward movement of the closing cover causes the output 84K to close. The closing cover is provided with a protrusion 450A which is configured to extend from the output 84K into the containing case 81.

The output 84K communicates with the introduction opening 153 of the dust separation part 52 through a communicating member 403.

A dust removing device is provided, which comprises a pair of protrusions 88 which are disposed with a predetermined interval in the vicinity of the connecting opening 84A of the front wall portion 84. The pair of protrusions 88 are configured to be in contact with projections 104Ab of mountains 104A of a pleated filter 104 of the pleated filter structure 100. Here, the mountains 104A are disposed to face an upstream side of air. A shaft 84J is formed in a central portion of the front wall portion 84, as shown in FIG. 29.

A dust receiving part 86 configured to receive dust removed from the pleated filter 104 is formed in an inner portion of the containing case 81.

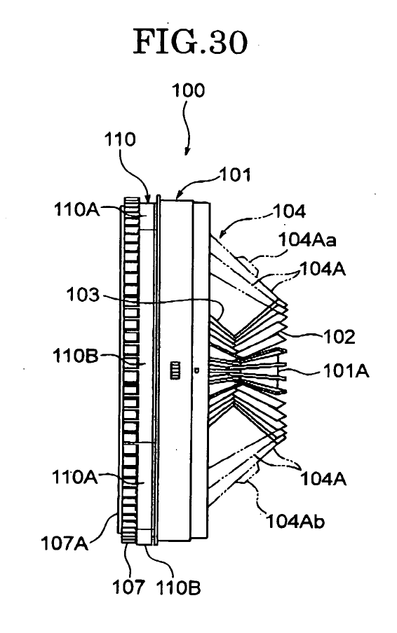

As shown in FIG. 30, the pleated filter structure 100 includes a cylindrical frame 101, a shaft portion 101A provided at a central position of the cylindrical frame 101, a plurality of ribs 102 and 103 to form pleats radially extending from the shaft portion 101A and a pleated filter 104 attached to the plurality of ribs 102 and 103.

As shown in FIG. 18, a shaft 84J provided on the front wall portion 84 is rotatably inserted in a hole 101Aa of the shaft portion 101A, and the pleated filter structure 100 is configured to be rotated about the shaft 84J.

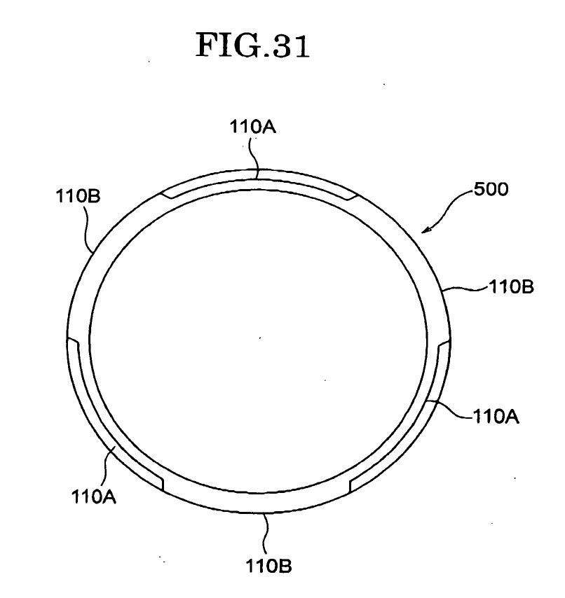

A cylindrical portion 500 having a short length is provided on a back end of the frame 101, as shown in FIG. 30. Three small diametrical portions 110A are formed on an outer peripheral surface of the cylindrical portion 500 with equal intervals along a circumferential direction thereof, as shown in FIG. 31. Large diametrical portions 110B are formed between the small diametrical portions 110A.

The small diametrical portions 110A and the large diametrical portions 110B are detected by a micro switch S1 (not shown) which is provided in the dust collection unit chamber 22 of the main body 11. In this embodiment, for example, when the large diametrical portions 110B are detected, the micro switch S1 is turned ON, when the small diametrical portions 110A are detected, the micro switch S1 is turned OFF.

As shown in FIG. 30, a gear 107 is formed on a back end surface of the cylindrical portion 500. The gear 107 and the cylindrical portion 500 are disposed to project out of the containing case 81, the gear 107 engages with a drive gear 110 provided on the dust collection unit chamber 22 of the main body 11, and the pleated filter structure 100 is rotated in containing case 81 by the drive of a motor M.

When the dust separation unit 400 is installed in the dust collection unit chamber 22 of the main body 11, the gear 107 is engaged with the drive gear 110. When lifting the dust separation unit 400 from the dust collection unit chamber 22, the gear 107 is disengaged from the drive gear 110, thereby the dust separation unit 400 is detached from the dust collection chamber 22 easily.

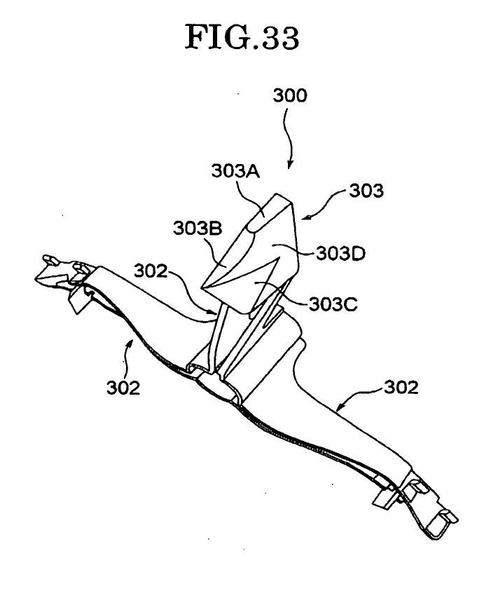

The dust discharge device 300 includes a shaft 301 fitted in the shaft portion 101A of the pleated filter structure 100 and rotated together therewith, for example, three arms 302 radially extending from the shaft 301, and a sweep-out member or discharge member 303 provided on a leading end of each of the arms 302. In FIG. 33, the two discharge members 303 are omitted.

A leading end portion of each discharge member 303 is configured to form a scraper which slides on an inner wall surface of the dust receiving part 86 of the containing case 81. The scraper includes a first sliding portion 303A and a second sliding portion 303B which is provided on one side of the discharge member 303 and slides on the front wall portion 84 of the containing case 81. An inclined surface or guiding inclined surface 303C is provided on another side of the discharge member 303.

The dust discharge device 300 is rotated together with the pleated filter structure 100. The rotation of the dust discharge member 303 causes the discharge member 303 to slide on the inner wall surface and the front wall portion of the dust receiving part 86 of the containing case 81 (see FIG. 29). By the sliding of the discharge member 303, it is configured to sweep dust accumulated in the dust receiving part 86 and discharge the dust from the output 84K.

When the discharge member 303 comes to a position of the output 84K, the discharge member 303 presses the protrusion 450A of the clog cover 450 to allow the closing cover 450 to move forwardly against the biasing force of the spring 401, whereby opening the output 84K.

Here, a mounting position of the micro switch S1 and a mounting position of the discharge member 303 on the pleated filter structure 100 are set so that the micro switch S1 is switched from ON to OFF, in other words, the micro switch S1 is switched from the large diametrical portion 110B to the small diametrical portion 110A in detection, when the pleated filter structure 100 is rotated and the discharge member 303 comes to a position as shown in FIG. 29.

When the discharge member 303 comes to the position as shown in FIG. 29, the output 84K is configured to be closed by the closing cover 450.

When the dust separation unit 400 is mounted on the dust collection unit chamber 22 of the main body 11, the back end surface of the containing case 81 of the dust separation unit 400 is jointed through the seal member 27 to the front opening 25B of the connecting passage 25 of the main body 11 to communicate the suction opening 24A of the electric blower 24 with the containing case 81 through the connecting passage 25.

A structure of a control system of the electric vacuum cleaner in the second embodiment is the same as in the first embodiment.

Generally, as shown in FIG. 17, the control system includes a control device which controls the electric blower 24, the motor M and so on based on detection signals of the micro switch S1 and the operational switches 13a of the operational part 13 A (see FIG. 1).

Next, operation of the electric vacuum cleaner in the second embodiment structured as mentioned above is described.

The dust collection unit 60 is first disposed in the dust collection unit chamber 22 of the main body 11, as shown in FIG. 18, one end of the dust collection hose 12 is connected to the connecting port 11A of the main body 11, and another end of the dust collection hose 12 is connected to the hood 15 through the operational tube 13 and the extension tube 14, as shown in FIG. 1.

A power plug (not shown) is connected to a plug outlet. This connection allows the motor M to drive by the control device 200 to rotate the pleated filter structure 100 of the filter part 80. As the pleated filter structure 100 rotates, the dust discharge device 300 rotates, the discharge member 303 of the dust discharge device 300 lifts the dust accumulated in the dust receiving part 86 along the inner wall surface in such a manner that the first sliding portion 303A slides on the inner wall surface of the dust receiving part 86.

In this way, because the rotation of the discharge member 303 causes the dust to lift along the inner wall surface of the dust receiving part 86 and move toward the outlet 84K, the lifting operation of dust can be carried out by a simple structure as mentioned above.

In addition, because the dust discharge device 300 is rotated depending on the rotation of pleated filter structure 100, they can be rotated by one drive source and a motor to drive the dust discharge device is not required.

When the discharge member 303 comes to the position of the outlet 84K, the second sliding portion 303B of the discharge member 303 presses the protrusion 450A of the closing cover 450 to open the closing cover 450.

On the other hand, the dust moved by the first sliding portion 303A of the discharge member 303 is dropped on the inclined surface 303C through the side surface 303D of the discharge member 303, and the dust is then discharged through the output 84K by the inclined surface 303C. The dust discharged from the output 84K is returned from the introduction opening 153 B of the dust separation part 52 to the separation chamber portion 54 through the communication member 403.

When the discharge member 303 comes to the position as shown in FIG. 29 by the rotation of the pleated filter structure 100, the detection of the micro switch S1 is switched from the large diametrical portion 110b to the small diametrical portion 110A to stop the motor M. When the discharge member 303 moves to the position shown in FIG. 29, the pressure of the protrusion 450A of the closing cover 450 by the second sliding portion 303B of the discharge member 303 is released, thereby the closing cover 450 closes the outlet 84K by the biasing force of the spring 401.

During the drive of the motor M, that is to say, until the output 84K is closed by the closing cover 450, even if the switches 13a of the operational part 13A are operated, the electric blower 24 is not driven. By the drive of the electric blower 24, air is vacuumed from the suction opening 24A of the electric blower 24 to generate a negative pressure in the containing case 81 of the dust collection unit 50 through the connecting passage 25 and in the dust collection case portion 74 and the separation chamber portion 54 of the dust separation part 52 through the suction passage portion 56. The negative pressure operates to the dust collection hose 12, the extension tube 14 and the hood 15 through the guide tube 57 to suck dust together with air through the hood 15.

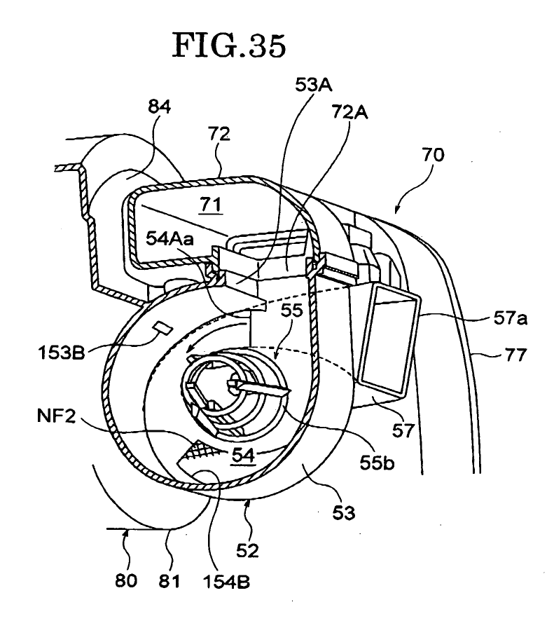

The sucked dust and air is moved to the suction connecting port 57a of the dust collection unit 50 through the extension tube 14 and the dust collection hose 12. The dust and air sucked to the suction connecting port 57a pass through the guide tube 57, introduced in the separation chamber portion 54 of the dust separation part 62, and rotated counterclockwise in the separation chamber portion 54, as shown in FIG. 35.

This rotation causes the dust and the air to separate by inertia, the separated air passes through the net filter NF1 (see FIG. 23) of the dust separation device 55 and the net filter NF2 of the opening 154B and further passes through the suction passage portion 56 to be sucked into the containing case 81 of the filter part 80.

On the other hand, the separated dust together with a part of air is introduced into the introduction opening 53A of the separation chamber portion 54 and the communicating case portion 72 of the dust collection part 70. The introduced dust and air are sucked to the dust collection chamber 73 passing through the communication passage 71 of the communicating case portion 72, and the dust is collected in the dust collection chamber 73.

The air sucked to the dust collection chamber 73 is sucked to the suction passage portion 56 passing through the net filter NF3 and the opening 170A of the lower portion of the cover plate 170, and further is sucked into the containing case 81 of the filter part 80.

The net filter NF3 is covered by the cover plate 170 at a remote position a predetermined interval and a great deal of air flow in a lower portion of the net filter NF3 by the opening 170A formed in the lower portion of the cover plate 170. Therefore, the net filter NF3 is configured to gradually generate clogging from the lower side thereof to be capable of accumulating a great deal of dust in the dust collection chamber 73.

The air sucked into the containing case 81 is sucked to the connecting passage 25 of the main body 11 passing through the pleated filter 104 of the pleated filter structure 100, further sucked into the suction opening 24A of the electric blower 24.

The air sucked into the suction opening 24A of the electric blower 24 is exhausted from the exhaust port 20H of the main body 11 passing through the electric blower 24, as shown in FIG. 18.

When the cleaning is completed, the electric blower 24 is stopped by operating one of the operational switches 13a of the operational part 13A. When stopping the electric blower 24, the control device 200 shown in FIG. 17 drives the motor M. Driving the motor M causes the drive gear 110 to rotate, whereby rotating the pleated filter structure 100.

By rotating the pleated filter structure 100, the protrusions 88 of the front wall portion 84 are in contact with projections 104Ab of the mountains 104A of the pleated filter 104 to give vibrations to the pleated filter 104, whereby removing the dust attached to the pleated filter 104. The removed dust is contained in the dust receiving part 86 of the containing case 81.

Because the protrusions 88 are disposed downwardly of the rotational center of the pleated filter structure 100, large vibrations are imparted to a lower portion of the pleated filter 104. Therefore, dust is removed from the lower portion of the pleated filter 104 and dropped into the dust receiving part 86. During the drop of dust, the dust is prevented from being attached to the pleated filter 104 again, whereby enable dropping the dust efficiently.

On the other hand, as the dust discharge device 300 rotates with the pleated filter structure 100, the first sliding portion 303A of the discharge member 303 slides on the inner wall surface of the dust receiving part 86. By the sliding, the dust accumulated in the dust receiving part 86 is moved along the inner wall surface.

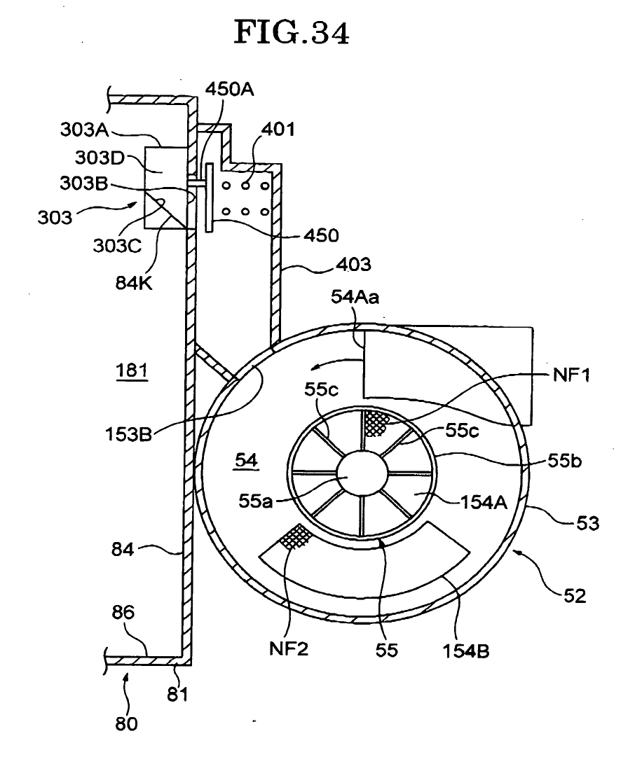

When the discharge member 303 comes to a position corresponding to the output 86K, the output 84K is opened as described above (see FIG. 34), the moved dust is ejected through the output 84K and returned to separation chamber portion 54 of the dust separation part 52 through the communicating member 403.

When the pleated filter structure 100 rotates one revolution, for example, and the discharge member 303 comes to the position shown in FIG. 29, the detection of the micro switch S1 is switched from the large diametrical portion 110B to the small diametrical portion 110A, thereby, the motor M and the pleated filter structure is stopped. In addition, the outlet 84K is closed by the closing cover 450, as mentioned above.

When the discharge member 303 of the dust discharge device 300 opens the outlet 84K, if the power plug is disengaged from the plug outlet, the motor M is stopped and the outlet 84K remains opened. However, as mentioned above, when the power plug is connected to the plug outlet, the motor M is driven to rotate the pleated filter structure 100. When the discharge member 303 comes to the position as shown in FIG. 29, the motor M is stopped to stop the discharge member 303 to a position shown by solid line in FIG. 16. Consequently, the outlet 84K is closed by the closing cover 460, and thereafter, the electric blower 24 is driven. Accordingly, there is no problem that the dust returned to separation chamber 64 of the dust separation part 52 is sucked through the outlet 84K to the filter.

In addition, because the dust contained in the dust receiving part 86 is returned from the outlet 84K through the communicating member 403 to the separation chamber portion 54 of the dust separation part 52 by rotation of the discharge member 303, a dust collection part used for the pleated filter 104 may not be provided on the dust collection part unit 410.

By use for a long period, if the pleated filter 104 is clogged with dust, the pleated filter can be cleaned by removing the dust separation unit 400 from the main body 11.

The removal of the dust separation unit 400 is performed after the dust collection part unit 410 is removed from the main body 11. However, only by the lifting of the dust separation unit 400, the gear 107 of the pleated filter structure 100 is removed from the drive gear 110 without it being interfered by the drive gear 110 because the drive gear 110 is disposed downwardly of the rotational center of the gear 107 of the pleated filter structure 100. Therefore, the dust separation unit 400 can easily be removed from the dust collection unit chamber 22 of the main body 11.

In mounting the dust separation unit 400 on the dust collection unit chamber 22, if the dust separation unit 400 is inserted in the dust collection unit chamber 22 from above, the dust separation unit 400 ran be easily mounted while the gear 107 of the pleated filter structure 100 engages with the drive gear 110, without the dust collection unit being interfered by the drive gear 110 because the drive gear 110 is disposed downwardly of the rotational center of the gear 107 of the pleated filter structure 100.

In the above-mentioned first and second embodiments, the dust discharged from the outlet 84K is returned to the separation chamber portion 54 of the dust separation part 52.

However, the present invention is not limited to those embodiments. For example, the dust may be returned to the guide tube 57 or dust collection part 70 which is disposed upstream of the dust separation part 52. Moreover, each of the above-mentioned first and second embodiments has been applied to an inertia-separation type-electric vacuum cleaner, but may be applied to, for example, a conventional electric vacuum cleaner using a paper filter.

In addition, in the first and second embodiments, the dust attached to the pleated filter 104 is removed by rotating the pleated filter structure 100. On the contrary, the protrusions 88 may be rotated without rotating the pleated filter structure 100 to impart vibrations to the pleated filter 104, whereby removing the dust attached to the pleated filter.

Although the above-mentioned second embodiment has been applied to a canister type-electric vacuum cleaner, it can be applied to an upright type-electric vacuum cleaner or electric vacuum cleaner in which a dust separation unit is attached to an operational tube at hand and so on.

According to the second embodiment, because the output is closed by the closing cover, even if the electric blower is driven, the dust is prevented from being attached to the secondary filter again. In addition, when the discharge member is moved to the position of the output, because the closing cover is opened, the dust discharged by the discharge member is ejected from the output, and the discharged dust is returned to the first separation part or upstream thereof, a dust collection part for the secondary filter is not required.

Next, a third embodiment of the electric vacuum cleaner according to the present invention is described.

In this embodiment, identity reference numbers are attached to the same parts as in the second embodiment, a description of the same parts is omitted.

Similarly to that in the second embodiment, a leading end portion of each discharge member 303 is co red to form a scraper which slides on an inner wall surface of the dust receiving part 86 of the containing case 81. The scraper includes a first sliding portion 303A and a second sliding portion 303B which is provided on one side of the discharge member 303 and slides on the front wall portion 84 of the containing case 81. An inclined surface or guiding inclined surface 303C is provided on another side of the discharge member 303.

As the dust discharge device 300 rotates with the pleated filter structure 100, the first sliding portion 303A of the discharge member 303 slides on the inner wall surface of the dust receiving part 86. By the sliding, the dust accumulated in the dust receiving part 86 is moved along the inner wall surface.

When the discharge member 303 comes to the position shown in FIG. 29, the outlet 84K is closed by the closing cover 450.

Next, operation of the electric vacuum cleaner according to the third embodiment is described.

A power plug (not shown) is connected to a plug outlet. This connection allows the motor M to drive by the control device 200 to rotate the pleated filter structure 100 of the filter part 80. As the pleated filter structure 100 rotates, the dust discharge device 300 rotates, the discharge member 303 of the dust discharge device 300 lifts up the dust accumulated in the duet receiving part 86 along the inner wall surface in such a manner that the first sliding portion 303A slides on the inner wall surface of the dust receiving part 86.

When the discharge member 303 comes to the position of the outlet 84K, the second sliding portion 303B of the discharge member 303 presses the protrusion 450A of the closing cover 450 to open the closing cover 450, as shown in FIG. 34.

On the other hand, the dust moved by the first sliding portion 303A of the discharge member 303 is dropped on the inclined surface 308C through the side surface 303D of the discharge member 303, and the dust is then discharged through the output 84K by the inclined surface 303C. The dust discharged from the output 84K is returned from the introduction opening 153 B of the dust separation part 52 to the separation chamber portion 54 through the communication member 403.

The third embodiment has a structure that the motor M is driven before the electric blower 24 is driven, to rotate the pleated filter structure 100 and the dust discharge device 300) and the discharge member 303 passes over the outlet 84K and stops at a position deviated from the outlet 84K.

Consequently, even if the outlet 84K is in an opened state, the outlet 84K is securely closed by the closing cover 460. Therefore, there is no problem that the dust returned to the separation chamber portion 54 of the dust separation part 52 is sucked through the outlet 84K.

Moreover, when the discharge member 303 of the dust discharge device 300 opens the outlet 84K, if the power plug is removed from the plug outlet, the motor M is stopped and the outlet 84K remains opened. However, as mentioned above, when the power plug is connected to the plug outlet, the motor M is driven to rotate the pleated filter structure 100. When the discharge member 303 comes to the position as shown in FIGS. 16 and 29, the motor M is stopped to stop the discharge member 303 to a position shown by solid line in FIG. 16. Consequently, the outlet 84K is closed by the closing cover 450, and thereafter, the electric blower 24 is driven. Accordingly, there is no problem that the dust returned to separation chamber 54 of the dust separation part 52 is sucked through the outlet 84K.

In addition, because the dust contained in the dust receiving part 86 is returned from the outlet 84K through the communicating member 403 to the separation chamber portion 54 of the dust separation part 52 by rotation of the discharge member 303, a dust collection part used for the pleated filter 104 may not be provided on the dust collection part unit 410.

According to the third embodiment, when the power is turned ON, or the drive of the electric blower 24 is started, because the discharge member is moved to stop it in the deviated position from the output, the outlet is closed by the closing cover when driving the electric blower, it is possible to prevent a problem that the dust ejected from the outlet is sucked to be attached to the secondary filter again.

Although the above-mentioned third embodiment has been applied to a canister type-electric vacuum cleaner, it can be applied to an upright type-electric vacuum cleaner or electric vacuum cleaner in which a dust separation unit is attached to an operational tube at hand and so on, similarly to the first and second embodiments.

Although the preferred embodiments of the present invention have been mentioned, the present invention is not limited to these embodiments, various modifications and changes can be made to the embodiments.

What is claimed is:

1. An electric vacuum cleaner, comprising:
a main body;
a filter located in a suction air trunk between an inlet to suck dust and a suction opening of an electric blower and provided in the main body to adsorb the dust;
a filter dust-removal device to remove the dust attached to the filter;
a dust receiving part to receive the dust removed from the filter and including an outlet through which the dust is discharged; and
a dust discharge device configured to discharge the dust in the dust receiving part from the outlet.

2. The electric vacuum cleaner according to claim 1,
wherein the dust discharge device includes a closing mechanism configured to close the outlet when the dust is discharged from the outlet.

3. The electric vacuum cleaner according to claim 1,
wherein the filter dust-removal device includes a drive section to rotate the filter and a removing member to remove the dust attached to the filter in contact with the rotating filter.

4. The electric vacuum cleaner according to claim 1,
wherein the dust discharge device includes a discharge member configured to move the dust contained in the dust receiving part to the outlet, and a drive mechanism to drive the discharge member.

5. The electric vacuum cleaner according to claim 2,
wherein the closing mechanism includes a discharge member configured to discharge the dust in the dust receiving part from the outlet and a closing member provided on the discharge member and configured to close the outlet when the dust is discharged from the outlet.

6. The electric vacuum cleaner according to claim 4,
wherein the dust discharge device further includes a positional detecting device configured to detect a position of the discharge member,
wherein the rotation of the filter is stopped when the positional detecting device detects that the discharge member is in the position of the outlet while the filter rotates.

7. The electric vacuum cleaner according to claim 4,
wherein the filter is rotated until the discharge member is moved to a position closing the outlet, when a power plug is connected to a plug outlet.

8. The electric vacuum cleaner according to claim 4,
wherein the electric blower is not driven while the discharge member moves to a position closing the outlet.

9. The electric vacuum cleaner according to claim 4,
wherein the discharge member is capable of closing the outlet when the electric blower is driven.

10. An electric vacuum cleaner, comprising:
a dust separation part provided in a suction air trunk between an inlet to suck dust and a suction opening of an electric blower in a main body and configured to separate the dust and air sucked in the inlet;
a dust collection part to collect the dust separated in the dust separation part;
a filter chamber disposed downstream of the dust separation part;
a secondary filter provided in the filter chamber;
a filter dust-removal device to remove dust attached to the secondary filter;
a dust receiving part which is provided in a sectioned wall to define the filter chamber between the dust separation part, an upstream or dust collection part and the secondary filter and configured to receive the dust removed by the filter dust-removal device;
an outlet provided in the sectioned wall to discharge the dust;
a closing cover to close the outlet; and
a movable discharge member configured to discharge the dust contained in the dust receiving part from the outlet,
wherein the closing cover opens the outlet when the discharge member is moved to a position of the outlet, and the dust moved by the discharge member is configured to be discharged from the outlet and returned to the dust separation part, the upstream or the dust collection part.

11. The electric vacuum cleaner according to claim 10,
wherein the closing cover is biased in a direction closing the outlet, and
wherein the discharge member is configured to open the closing cover against a biasing force.

12. The electric vacuum cleaner according to claim 10,
wherein the outlet is formed in an upper portion of the sectioned wall,
the dust receiving part being formed in a cylindrical shape,
the discharge member being rotated about a center of the dust receiving part and configured to discharge the dust contained in the dust receiving part.

13. The electric vacuum cleaner according to claim 10,
wherein the filter dust-removal device is configured to remove the dust from the secondary filter as the secondary filter rotates,
wherein the discharge member rotates together with the secondary filter.

14. The electric vacuum cleaner according to claim 11,
wherein a protrusion is provided on the closing cover,
the discharge member including a first sliding portion to slide on an inner wall surface of the dust receiving part, a second sliding portion to slide on the sectioned wall and a guiding inclined surface to guide the dust removed from the secondary filter to the outlet,
wherein the second sliding portion presses the protrusion to open the closing cover against the biasing force when the discharge member moves at a position of the outlet.

15. An electric vacuum cleaner, comprising:
a dust separation part provided in a suction air trunk between an inlet to suck dust and a suction opening of an electric blower in a main body and configured to separate the dust and air sucked in the inlet;
a secondary filter provided downstream of the dust separation part;
a filter dust-removal device to remove dust attached to the secondary filter;
a dust receiving part configured to receive the dust removed by the filter dust-removal device;
an air trunk wall defining an air trunk between the dust separation part and the secondary filter;
an outlet provided in the dust receiving part or the air trunk wall a closing cover to close the outlet;
a movable discharge member configured to discharge the dust contained in the dust receiving part from the outlet; and
a dust collection part to contain the dust separated in the dust separation part,
wherein the closing cover opens the outlet when the discharge member is moved to a position of the outlet, and the dust moved by the discharge member is configured to be discharged from the outlet to the dust separation part, the upstream or the dust collection part,
wherein the moving discharge member is stopped at a deviated position from the outlet when a power is turned-on, or when starting drive of the electric blower.

16. The electric vacuum cleaner according to claim 15,
wherein the discharge member is configured to pass over the outlet and stop at the deviated position from the outlet.

17. The electric vacuum cleaner according to claim 15,
further comprising a detector to detect a position of the discharge member,
wherein the filter dust-removal device is configured to remove the dust from the secondary filter as the secondary filter rotates,
the dust receiving part being formed by a cylindrical portion to surround the secondary filter,
the discharge member being rotated together with the secondary filter and sweeping-out the dust on an inner peripheral surface of the cylindrical portion, and
the discharge member being stopped based on an output of the detector.

18. The electric vacuum cleaner according to claim 1,
wherein the filter dust-removal device is configured to remove the dust from the filter, when the electric blower is stopped.
